(19) United States
(12) Patent Application Publication
(10) Pub. No.: US 2024/0353328 A1
(43) Pub. Date: Oct. 24, 2024

(54) ELECTROPHORESIS DATA PROCESSING DEVICE AND ELECTROPHORESIS DATA PROCESSING METHOD

(71) Applicant: HITACHI HIGH-TECH CORPORATION, Tokyo (JP)

(72) Inventors: Naoya MUROOKA, Tokyo (JP); Noriyuki SUMIDA, Tokyo (JP); Motohiro YAMAZAKI, Tokyo (JP); Isao HARAURA, Tokyo (JP); Daisuke MORISHIMA, Tokyo (JP)

(21) Appl. No.: 18/684,867

(22) PCT Filed: Oct. 5, 2021
(86) PCT No.: PCT/JP2021/036764

§ 371 Date: Feb. 20, 2024

(51) Int. Cl. G01N 21/64; H04N 25/46

(52) U.S. Cl. CPC G01N 21/6428; G01N 21/6456; H04N 25/46; G01N 2021/6439

(57) ABSTRACT

An electrophoresis device comprising: a signal charge data acquisition unit, when CCD image sensors detect a signal for each wavelength of fluorescence of a fluorescent label and output pixel data by conversion of the signal into an electric signal, acquiring a signal value output from the CCD image sensor; a binning processing unit combining pixels into one bin; a color conversion processing unit calculating the signal intensity of each fluorescent label; a color signal evaluation processing unit calculating a color signal evaluated value indicating the degree of variation in the signal intensity of each fluorescent label; and a binning area adjustment processing unit making an bin adjustment to reduce the size of the relevant bin of the fluorescent label with the largest signal intensity peak value and to expand the size of the relevant bin of the fluorescent label with the smallest signal intensity peak value.

### TECHNICAL FIELD

This invention relates to a technology of an electrophoresis data processing device and an electrophoresis data processing method.

### BACKGROUND ART

Capillary electrophoresis devices have been known. In such a capillary electrophoresis device, a sample in which a plurality of fluorescent labels are given to DNA is electrophoresed inside a capillary and a detection area is irradiated with excitation light to detect the fluorescence emitted from the sample as a signal.

The fluorescence generated by the sample is dispersed in the wavelength direction and detected by a device that converts a light signal into an electric signal for each wavelength band. Such a device may be, for example, a CCD (Charge Coupled Device) image sensor or CMOS (Complementary Metal-Oxide Semiconductor) image sensor.

In obtaining a fluorescent signal, binning is known in which a plurality of light receiving surfaces (corresponding to pixels) of the image sensor are combined in a simulated manner and treated as one pixel to increase or decrease the light receiving area of one pixel.

Patent Literature 1 to 3 disclose this kind of binning technique.

Patent Literature 1 discloses a capillary array electrophoresis device and a fluorescence detection device, and a fluorescent signal intensity acquisition method in which “a fluorescence detection device 400 has a plurality of light receiving surfaces to generate a signal charge by irradiating a fluorescent signal 405 and acquires a fluorescent signal intensity based on a plurality of signal charges generated on the light receiving surfaces, and the fluorescence detection device 400 acquires the fluorescent sight signal intensity by performing either hardware binning to acquire a fluorescent signal intensity by converting the plurality of signal charges collectively or software binning to acquire a fluorescent signal intensity by converting the signal charges into a fluorescent signal intensity one by one and adding the converted fluorescent signal intensity” (see the abstract).

Patent Literature 2 discloses a fluorescence analysis device and an analysis method, in which “a fluorescence analysis device 1A comprises: an excitation light irradiation system to irradiate a sample S with excitation light; a fluorescence detection system to detect fluorescence from a fluorescence probe in a measurement area; a photon counter 35 to count the number of photons according to a detection signal; an analysis condition setting unit 51 to set analysis conditions for photon number measurement data; and a measurement result analysis unit 52 to make a fluorescence analysis. The setting unit 51 is used to set the bin width for binning of measurement data and a reference number of photons for one fluorescence probe molecule, the analysis unit 52 performs binning of measurement data and analyzes the number of fluorescence probes in the measurement area in reference to the reference number of photons. Also, the setting unit 51 sets bin width using the photon number measurement SN ratio and change in the reference SN ratio with bin width due to shot noise characteristics” (see the abstract).

Patent Literature 3 discloses a fluorescence observation device as a “fluorescence observation device 100 that comprises a fluorescence image acquisition unit 18 and reference image acquisition unit 17 to acquire a fluorescence image or reference image of an object A; a division image generating unit 64 to generate a division image by dividing an image based on the fluorescence image by an image based on the reference image; a display unit 20 to display a final fluorescence image based on the division image; a correction unit 65 to perform correction of at least one of the reference image and the fluorescence image and/or the division image before the division image generating unit 64 generates the division image or the display unit 20 displays the final fluorescence image; an observation condition decision unit 7 to decide the observation condition for the object A; and a correction condition setting unit 66 to set a parameter for correction by the correction unit 65 according to the observation condition decided by the observation condition decision unit 7 (see the abstract).

A combination of binning areas which are applied in binning is called a binning pattern.

### CITATION LIST

### Patent Literature

Patent Literature 1: Japanese Unexamined Patent Application Publication No. 2015-49179
Patent Literature 2: Japanese Unexamined Patent Application Publication No. 2009-192490
Patent Literature 3: Japanese Unexamined Patent Application Publication No. 2013-56001

### SUMMARY OF INVENTION

### Technical Problem

According to the technique described in Patent Literature 1, improvement in data acquisition speed and reduction in acquired data size can be achieved. If the purpose is simply reduction in data size, it can be easily achieved by fixing the binning area and performing binning at regular intervals. In addition, as described in Patent Literature 2 and Patent Literature 3, S/N ratio can be improved by changing the area for binning a fluorescent signal. However, in adjustment of the binning area for improvement in S/N ratio, the fluoresce sensitivity of each fluorescence label may vary according to the wavelength characteristics of the fluorescent label.

The electrophoresis device must detect and analyze the fluorescence derived from a plurality of fluorescent labels simultaneously, so a satisfactory analysis performance cannot be achieved without suppressing variation in fluorescence sensitivity.

In suppressing the variation, adjustment to optimize the binning pattern for the fluorescent label set to be used is necessary. However, this adjustment work has a problem that it requires a worker with a high specialist skill and it takes time and is costly.

The present invention has been made in consideration of this background and the present invention has an object to improve the analysis accuracy of the electrophoresis device.

### Solution to Problem

In order to solve the above problems, an electrophoresis data processing device of this invention includes: an acquisition unit that, when a plurality of imaging elements of an electrophoresis device in which a plurality of fluorescent labels are migrated together with a sample detect a signal for each wavelength component of fluorescence of the fluorescent labels and output pixel data obtained by conversion of the signal into an electric signal, acquires the pixel data output from the imaging elements from each of the imaging elements; a bin generating unit that calculates an integrated value or a representative value of values of a given number of the adjacent pixel data, takes the calculated integrated value or the calculated representative value as a bin value, to combine the given number of the adjacent pixel data into one bin; a bin value extraction unit that extracts a set of the bin values derived from the fluorescent labels for each of the fluorescent labels; a signal intensity calculation unit that calculates a signal intensity of each of the fluorescent labels based on the set of the extracted bin values; a first evaluated value calculation unit that calculates a first evaluated value as an evaluated value indicating a degree of variation in the signal intensity of each of the fluorescent labels; and an adjustment unit that, when the first evaluated value satisfies a prescribed condition, makes a bin adjustment to reduce a size of the bin with the largest bin value in the set of bin values for the fluorescent label with the largest value of a first peak as a signal intensity peak, and to expand the size of the bin with the largest bin value for the fluorescent label with the smallest value of the first peak.

Other solutions are appropriately described in embodiments.

### Advantageous Effects of Invention

It is possible to improve the analysis accuracy of the electrophoresis device.

### BRIEF DESCRIPTION OF DRAWINGS

FIG. 1 is a diagram that shows an example of the configuration of the electrophoresis system according to the first embodiment.

FIG. 2 is a diagram that shows the hardware configuration of the electrophoresis data processing device.

FIG. 3A is a diagram (1) that shows an example of binning used in this embodiment.

FIG. 3B is a diagram (2) that shows an example of binning used in this embodiment.

FIG. 4A is a diagram that shows the relation between bin and wavelength.

FIG. 4B is a diagram that shows an example of a signal charge integrated value.

FIG. 5 is a flowchart that shows an example of electrophoresis data processing according to the first embodiment.

FIG. 6 is a flowchart that shows an example of the binning processing steps to be performed in the first embodiment.

FIG. 7 is a flowchart that shows an example of the color conversion matrix calculation processing steps to be performed in the first embodiment.

FIG. 8 is a graph that shows an example of signal charge integration data.

FIG. 9 is a graph that shows an example of a signal charge integrated value after normalization.

FIG. 10 is a flowchart that shows the color conversion processing steps to be performed in the first embodiment.

FIG. 11 is a graph that shows an example of fluorescent color signal data.

FIG. 12 is a flowchart that shows the fluorescent color signal evaluation calculation processing steps to be performed in the first embodiment.

FIG. 13 is a graph that shows an example of a signal intensity average value.

FIG. 14 is a flowchart that shows the binning area adjustment processing steps.

FIG. 15A is a diagram that shows an example of the menu screen (1).

FIG. 15B is a diagram that shows an example of the dialog screen.

FIG. 15C is a diagram that shows an example of the menu screen (1).

FIG. 15D is a diagram that shows an example of the fluorescence sensitivity adjustment screen.

FIG. 16 is a graph that shows an example of fluorescent color signal data resulted from completion of the sensitivity adjustment process according to the first embodiment.

FIG. 17 is a diagram that shows an example of the configuration of the electrophoresis system according to the second embodiment.

FIG. 18 is a flowchart that shows an example of electrophoresis data processing to be performed in the second embodiment.

FIG. 19 is a diagram that shows an example of the configuration of the electrophoresis system according to the third embodiment.

FIG. 20 is a flowchart that shows an example of electrophoresis data processing to be performed in the third embodiment.

FIG. 21 is a graph that shows an example of fluorescent color signal data in which pullup has occurred.

### DESCRIPTION OF EMBODIMENTS

Hereinafter, embodiments of the present invention (“referred to as embodiments”) will be described in detail referring to drawings. In all the drawings that illustrate the embodiments, the same elements are designated by the same reference signs and repeated description thereof is omitted.

### First Embodiment

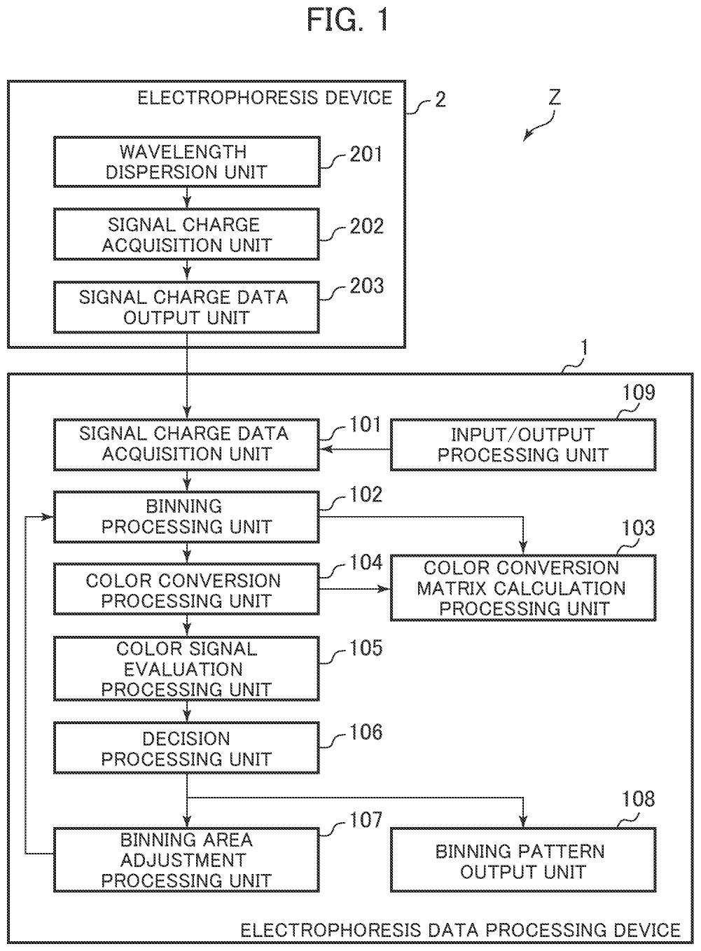

First, the first embodiment of the present invention will be described referring to FIG. 1 to FIG. 15D.

### [Electrophoresis System Z]

FIG. 1 is a diagram that shows an example of the configuration of the electrophoresis system Z according to the first embodiment.

The electrophoresis system Z includes an electrophoresis data processing device 1 and an electrophoresis device 2.

### (Electrophoresis Device 2)

The electrophoresis device 2 electrophoreses a biological sample and irradiates the fluorescent label in the measurement sample with excitation light to make the measurement sample generate fluorescence and detect a fluorescent signal. In short, the electrophoresis device 2 is provided as an electrophoresis device 2 in which a plurality of fluorescent labels are migrated with a sample. In this embodiment, the sample as the object of measurement in the electrophoresis device 2 is a DNA molecule to which a plurality of fluorescent labels are given. In these DNA molecules, fluorescent labels are given to the base information of DNA molecules (“ATGC”) and characteristic sequence architecture (for example, continuous “T” part). As the electrophoresis device 2, a capillary electrophoresis device or the like is used.

The electrophoresis device 2 includes a wavelength dispersion unit 201, a signal charge acquisition unit 202, and a signal charge data output unit 203.

The wavelength dispersion unit 201 is, for example, a diffraction grating and disperses the fluorescence generated by a fluorescent label in a wavelength direction.

The signal charge acquisition unit 202 detects the fluorescent signal dispersed in the wavelength direction by the wavelength dispersion unit 201 (fluorescence detection) and converts it into an electric signal. In other words, it detects the signal of the wavelength component of the fluorescence from the florescent label dispersed by the wavelength dispersion unit 201. The signal charge acquisition unit 202 includes, for example, a CCD image sensor or CMOS image sensor (imaging element) or the like. In this embodiment, the signal charge acquisition unit 202 uses a CCD image sensor. Furthermore, fluorescence detection by the signal charge acquisition unit is performed as many times as desired in each time series as the electrophoresis time elapses. Specifically, fluorescence detection is performed two or more times in each prescribed time period during electrophoresis. Each fluorescence detection is taken as one scan.

The signal charge data output unit 203 outputs the pixel data (signal charge data) sent from each of the CCD image sensors (imaging elements) of the signal charge acquisition unit 202, to the electrophoresis data processing device 1.

### (Electrophoresis Data Processing Device 1)

The electrophoresis data processing device 1 outputs the optimized binning pattern for the fluorescent label to be used, by using the signal charge data in each time series which has been received from the electrophoresis device 2. In other words, the electrophoresis data processing device 1 decides whether the binning pattern given by default (preset) is optimal or not and if not optimal, adjusts the binning pattern. If the binning pattern is optimal, the electrophoresis data processing device 1 outputs the binning pattern.

The electrophoresis data processing device 1 includes a signal charge data acquisition unit 101, a binning processing unit 102, a color conversion matrix calculation processing unit 103, a color conversion processing unit 104, a color signal evaluation processing unit 105, a decision processing unit 106, a binning area adjustment processing unit 107, a binning pattern output unit 108, and an input/output processing unit 109.

The signal charge data acquisition unit 101 (acquisition unit) receives the signal charge data from the electrophoresis device 2. Specifically, it receives the signal charge data as pixel data output from the CCD image sensors (imaging elements) of the electrophoresis device 2, from each CCD image sensor (imaging element).

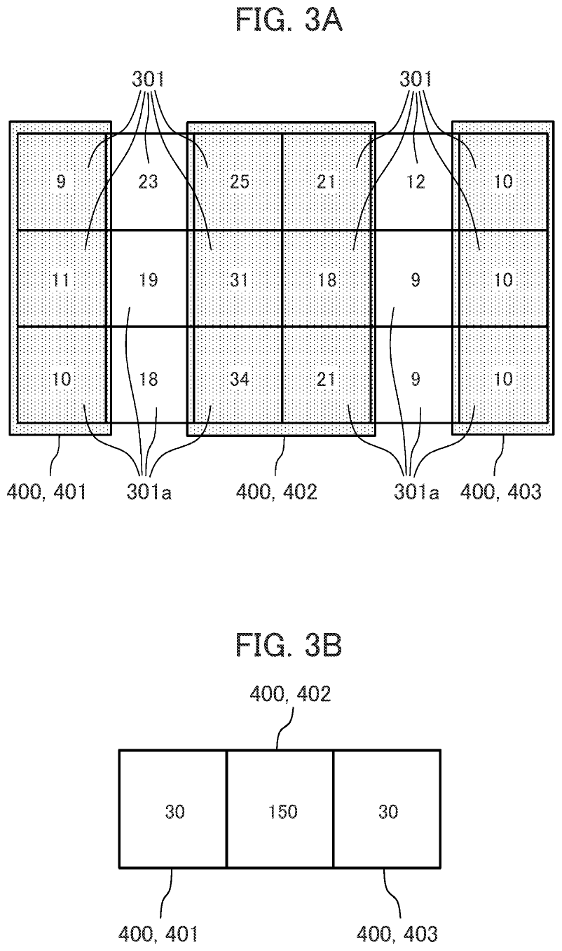

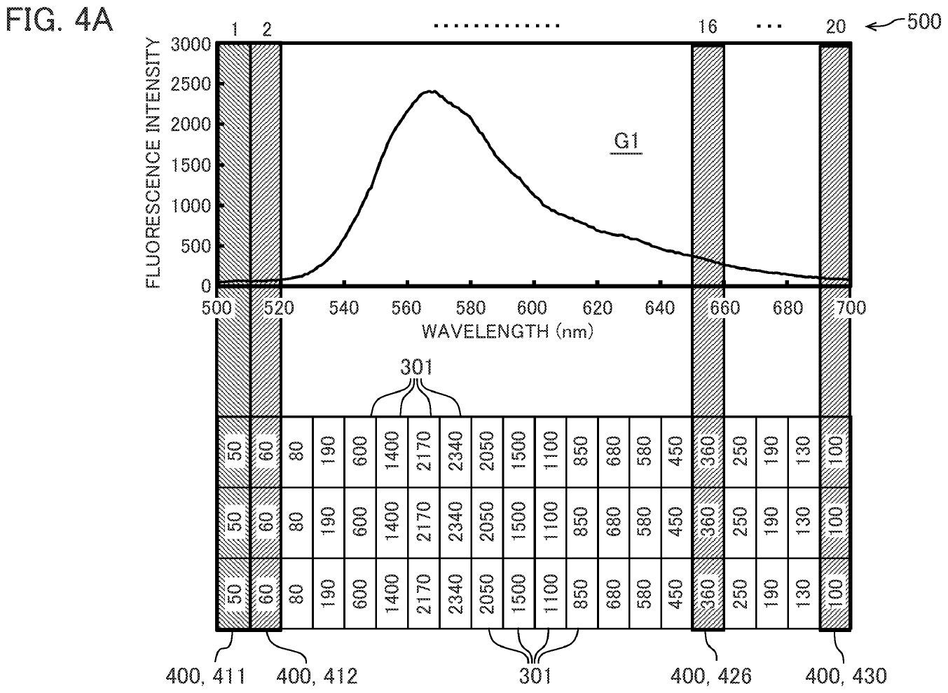

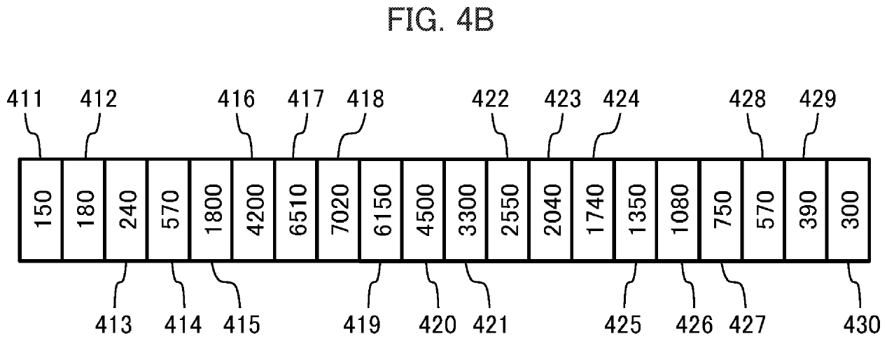

The binning processing unit 102 (bin generating unit) performs binning processing. At this time, the binning processing unit 102 divides the acquired signal charge data into bins 400 (see FIG. 3A to FIG. 4A) according to a binning pattern (for example, a preset default binning pattern), integrates the signal values of each bin 400 and outputs it as signal charge integration data (bin value). A representative value may be used instead of integration. The representative value will be described later.

Although the bin 400 (see FIG. 3A, etc.) will be described later, the values (signal values) of a given number of adjacent pixel data are grouped into one bin 400. The binning pattern is a pattern concerning how to group pixel data in bins 400. The binning pattern and the processing which is performed by the binning processing unit 102 will be explained later.

In this way, the binning processing unit 102 calculates an integrated value or representative value of the values of a given number of adjacent pixel data and takes the calculated integrated value or representative value as a bin value to group the given number of adjacent pixel data into one bin.

The color conversion matrix calculation processing unit 103 (bin value extraction unit) generates a color conversion matrix [C] based on the signal charge integration data output from the binning processing unit 102 and outputs it. The processing which is performed by the color conversion matrix calculation processing unit 103 will be described later. In this embodiment, “color” means fluorescent color of a fluorescent label. The color conversion matrix calculation processing unit 103 extracts F (signal charge integration data) derived from a fluorescent label for each fluorescent label by calculating the color conversion matrix [C].

The color conversion processing unit 104 (signal intensity calculation unit) calculates the signal component derived from a fluorescent label based on the signal charge integration data output by the binning processing unit 102 and the color conversion matrix [C] output by the color conversion matrix calculation processing unit 103. The signal component derived from a fluorescent label includes the signal intensity of each fluorescent label (which will be detailed later). Then, the color conversion processing unit 104 outputs the calculated signal component derived from the fluorescent label (signal intensity of each fluorescent label) as fluorescent color signal data. In this way, the color conversion processing unit 104 calculates the signal intensity of each fluorescent label based on a set of extracted bin values (signal charge integration data). The processing which is performed by the color conversion processing unit 104 will be described later.

The color signal evaluation processing unit 105 calculates a fluorescent color signal evaluated value (first evaluated value) based on the fluorescent color signal data output by the color conversion processing unit 104. The fluorescent color signal evaluated value indicates the degree of variation in signal intensity of each fluorescent label. Specifically, the color signal evaluation processing unit 105 decides whether the fluorescent color signal evaluated value is smaller than a prescribed threshold or not. By doing so, the color signal evaluation processing unit 105 decides whether the degree of variation in the signal intensity of each fluorescent label is smaller than a prescribed threshold or not. In other words, the color signal evaluation processing unit 105 decides whether variation in the signal intensity of each fluorescent label is suppressed or not. If the fluorescent color signal evaluation value is less than a prescribed threshold (the prescribed condition is satisfied), the variation in the signal intensity of each fluorescent label is suppressed and thus the color signal evaluation processing unit 105 determines that the current binning pattern is optimal. Conversely, if the fluorescent color signal evaluated value is not less than the prescribed threshold (the prescribed condition is not satisfied), the variation in the signal intensity of each fluorescent label is not suppressed and thus the color signal evaluation processing unit 105 determines that the binning pattern must be corrected. Thus, the fluorescent color signal evaluated value indicates the degree of variation in the signal intensity of each fluorescent label and is an evaluated value to decide whether the current binning patter is optimal or not.

The processing which is performed by the color signal evaluation processing unit 105 will be described later.

The decision processing unit 106 decides whether the fluorescent color signal evaluated value calculated by the color signal evaluation processing unit 105 is not less than the threshold or less than the threshold. By doing so, the decision processing unit 106 decides whether the current binning pattern is optimal or not. The processing which is performed by the decision processing unit 106 will be described later.

If the decision processing unit 106 decides that the fluorescent color signal evaluated value is less than the threshold, namely the current binning pattern is not optimal, the binning area adjustment processing unit 107 adjusts the binning pattern. The processing which is performed by the binning area adjustment processing unit 107 will be described later.

If the decision processing unit 106 decides that the fluorescent color signal evaluated value is not less than the threshold, namely the current binning pattern is optimal, the binning pattern output unit 108 outputs the current binning pattern to the outside.

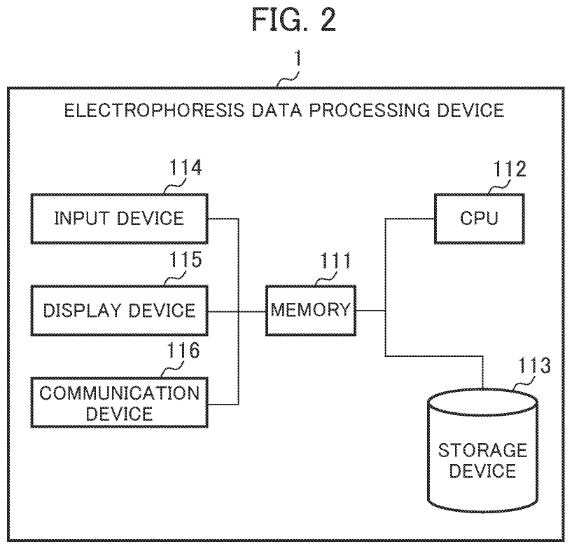

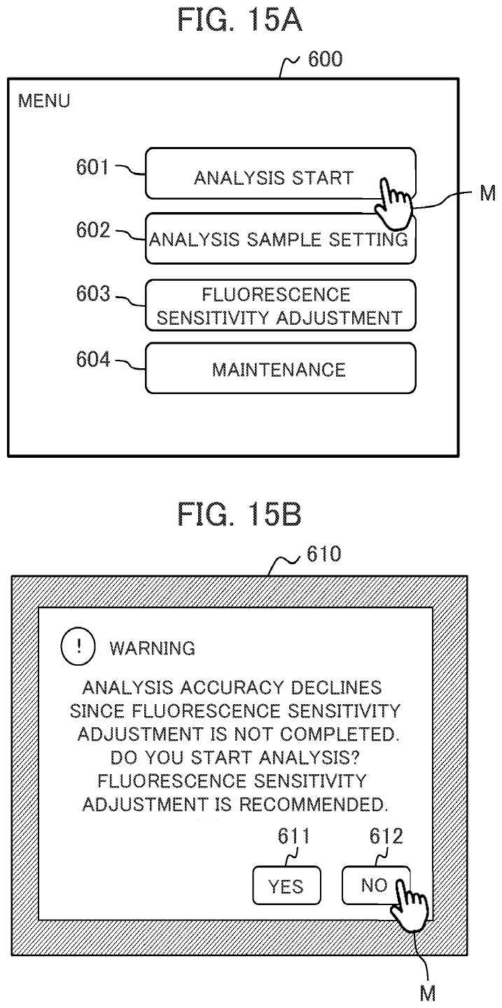

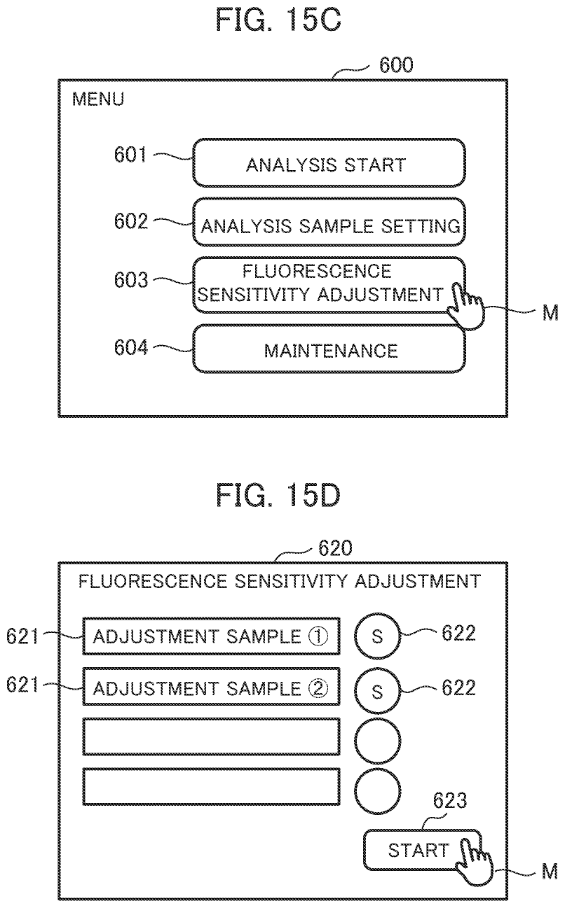

The input/output processing unit 109 outputs various screens 600, 610, and 620, which will be described referring to FIG. 15A to FIG. 15D, to a display device 115 (see FIG. 2). The input/output processing unit 109 receives the information entered through an input device 114 (see FIG. 2). When an instruction is given from the input/output processing unit 109, the units 101 to 108 start processing.

### [Hardware Configuration]

FIG. 2 is a diagram that shows the hardware configuration of the electrophoresis data processing device 1.

The electrophoresis data processing device 1 includes a memory 111, a CPU (Central Processing Unit) 112, and a storage device 113 such as HD (Hard Disk). In addition, the electrophoresis data processing device 1 includes an input device 114 such as a keyboard and mouse, a display device 115 such as a display, and a communication device 116. The communication device 116 acquires data from the electrophoresis device 2.

The program stored in the storage device 113 is loaded onto the memory 111. The loaded program is executed by the CPU 112. Consequently, the various units 101 to 108 shown in FIG. 1 are embodied.

In the example shown in FIG. 1, the units 101 to 108 are independent, but each unit may include one or two or more elements as necessary. For example, each of the units 101 to 108 may use one or two or more central processing units (CPU 112) to perform processing. In other words, in the example shown in FIG. 1, the electrophoresis data processing device 1 includes all the units 101 to 108, but instead, some of them may be provided in another device than the electrophoresis data processing device 1. For example, the electrophoresis device 2 may include the binning processing unit 102 or the color conversion matrix calculation processing unit 103 may be provided in another device than the electrophoresis data processing device 1.

### [Binning]

FIG. 3A and FIG. 3B show an example of binning which is used in this embodiment.

FIG. 3A shows 3×6 CCD pixels 301. In FIG. 3A, the numerical value inside each CCD pixel 301 means the signal value (value of pixel data) which is detected by each CCD pixel 301.

When fluorescence is detected by a CCD image sensor, the method of increasing the light receiving area of each pixel, which is called “binning,” is known in which a given number of adjacent CCD pixels 301 are grouped and treated as one bin 400 (pixel data is combined into one bin). In binning, the area of a bin 400 which combines CCD pixels 301 is predetermined. The combination (grouping) of CCD pixels 301 in each bin 400 is called binning pattern.

In the example shown in FIG. 3A, the shaded portion is a bin 400. As shown in FIG. 3A, each bin 400 has a plurality of CCD pixels 301.

For example, as shown in FIG. 3A, the bin 401 on the left has three CCD pixels 301, the bin 402 in the center has six CCD pixels 301, and the bin 403 on the right has three CCD pixels 301.

As shown by the example in FIG. 3A, the number of CCD pixels 301 in each bin 400 may be different. Also, like the CCD pixel 301a in FIG. 3A, some CCD pixels 301 may not be included in a bin 400.

FIG. 3B is a diagram that shows a signal charge integrated value of each bin 400.

In FIG. 3B, bins 401 to 403 are bins 400 which correspond to bins 401 to 403 in FIG. 3A. In FIG. 3B, the numerical values in bins 401 to 403 indicate the signal charge integrated values (bin value) of the bins 400. The signal charge integrated values of the bins 401 to 403 are integrated values of signal values (values of pixel data) output by the CCD pixels 301 of the bin 400.

These bins 400 are generated by the binning processing unit 102. In short, the binning processing unit 102 sums up the signal values of a given number of adjacent CCD pixels 301 (integrates a given number of adjacent pixel data) into one bin 400.

For example, the signal charge integrated value of the bin 401 shown in FIG. 3B (“30”) is the integrated value of the signal values (“9”, “11”, “10”) of the CCD pixels 301 constituting the bin 401 in FIG. 3A. The same is true for the bins 402 and 403. In this way, the signal charge integrated value is the integrated value of values (signal values) of the above pixel data of each bin 400.

In this way, a given number of adjacent CCD pixels 301 (pixel data) which are output from imaging elements such as CCD image sensors are grouped into one bin 400.

### [Relation Between Bin 400 and Wavelength]

FIG. 4A is a diagram that shows the relation between bin 400 and wavelength. In explanation, reference will be made to FIG. 1 as necessary.

As explained above, in the electrophoresis device 200, wavelength-dispersed fluorescence is detected by a CCD pixel 301 of the signal charge acquisition unit 202.

In FIG. 4A, graph G1 indicates the wavelength spectrum of the fluorescence wavelength-dispersed by the electrophoresis device 200. In graph G1, the horizontal axis denotes wavelength and the vertical axis denotes fluorescence intensity.

As shown in FIG. 4A, CCD pixels 301 (namely, CCD image sensors) are arranged in the wavelength direction in the signal charge acquisition unit 202.

In other words, in this embodiment, the signal value detected by each CCD pixel 301 corresponds to fluorescence intensity in the wavelength direction.

In the example shown in FIG. 4A, the bin 400 is uniformly comprised of three CCD pixels 301. The numerical value in each CCD pixel 301 is the signal value output from that CCD pixel 301. As shown in FIG. 4A, a plurality of CCD image sensors (imaging elements) detect the signal of each wavelength component of the fluorescence from a fluorescence label and the signal is converted into an electric signal and output as pixel data.

The example shown in FIG. 4A shows a case that the signal charge acquisition unit 202 can acquire the wavelength band of 500 nm to 700 nm. CCD pixels 301 are arranged in a manner that the wavelength band assigned to one bin 400 is 10 nm. Specifically, wavelengths of 500 to 510 nm are assigned to bin 411, 510 to 520 nm are assigned to bin 412 and 690 to 700 nm are assigned to bin 430. In short, a binning pattern in which the wavelength band of 500 nm to 700 nm is divided by 20 bins 400 is shown here as an example. Reference sign 500 designates bin numbers 1 to 20. Bin numbers are numbers which are uniquely assigned to bins 411 to 430. Needless to say, for a binning pattern, the number of bins 400 is not limited to 20. The wavelengths acquired by the signal charge acquisition unit 202 need not cover the entire wavelength band (500 to 700 nm in the example of FIG. 4A).

FIG. 4B is a diagram that shows an example of signal charge integrated values (bin values) of the bins 400 shown in FIG. 4A.

Bins 411 to 430 shown in FIG. 4B correspond to bins 411 to 430 shown in FIG. 4A. The numerical values inside bins 411 to 430 indicate the signal charge integrated value of each of bins 411 to 430. The numerical value inside each of bins 411 to 430 in FIG. 4B is the sum (integrated value) of signal charge integrated values which are output from the CCD pixels 301 which constitute each of the bins 411 to 430.

### [Overall Process]

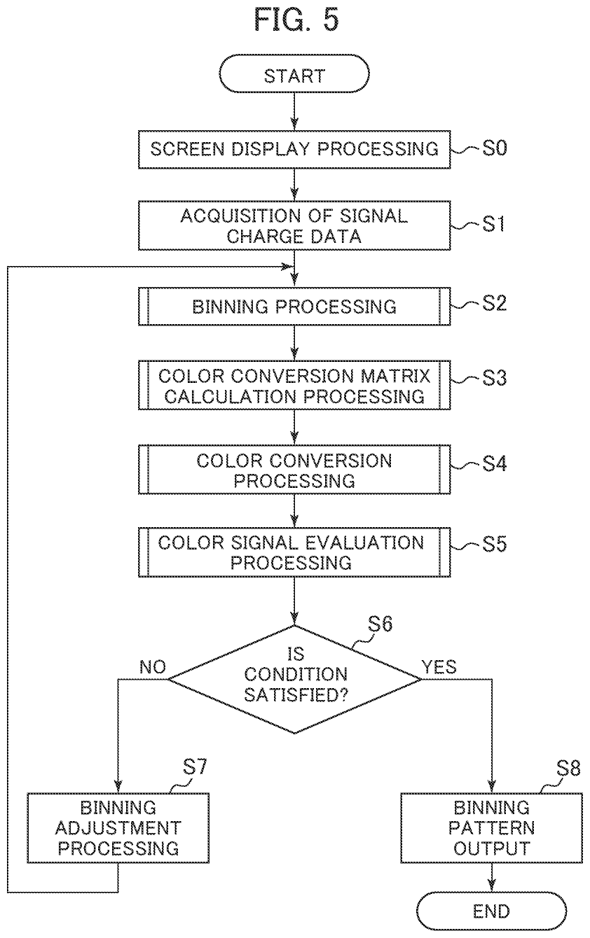

FIG. 5 is a flowchart that shows an example of electrophoresis data processing steps according to the first embodiment.

The explanation will be made referring to FIG. 1 and FIG. 2 as necessary.

First, the input/output processing unit 109 performs processing to display a screen on the display device 115 (S0). The screens which are displayed at Step S0 will be explained later referring to FIG. 15A to FIG. 15D.

As the input/output processing unit 109 gives an instruction to start processing, the signal charge data acquisition unit 101 acquires signal charge data from the electrophoresis device 2 (S1). The signal charge data is data (pixel data) which is output from the signal charge data output unit 203 of the electrophoresis device 2. Specifically, it is a signal value (value of pixel data) shown in each CCD pixel 301 in FIG. 3A and FIG. 4B. In short, the signal charge data acquisition unit 101 (acquisition unit) acquires CCD pixels 301 (pixel data) output from the CCD image sensors (imaging elements) from each CCD image sensor (imaging element).

Next, the binning processing unit 102 performs binning processing (S2). Step S2 will be explained later.

Then, the color conversion matrix calculation processing unit 103 performs color conversion matrix calculation processing (S3). Step S3 will be explained later.

Next, the color conversion processing unit 104 performs color conversion processing (S4). Step S4 will be explained later.

Furthermore, the color signal evaluation processing unit 105 performs color signal evaluation processing (S5). Step S5 will be explained later. At Step S5, the color signal evaluation processing unit 105 calculates a fluorescent color signal evaluated value.

Then, the decision processing unit 106 decides whether the fluorescent color signal evaluated value calculated by the color signal evaluation processing unit 105 satisfies a prescribed condition or not (S6). Step S6 will be explained later.

If the fluorescent color signal evaluated value does not satisfy the prescribed condition (S6→No), the binning area adjustment processing unit 107 performs binning adjustment processing (S7). Then, the electrophoresis data processing device 1 returns the process to Step S2. The processing at Step S7 will be explained later.

If the fluorescent color signal evaluated value satisfies the prescribed condition (S6→Yes), the binning pattern output unit 108 outputs a binning pattern.

Next, each step of the process shown in FIG. 5 will be explained in detail.

### [Binning Process]

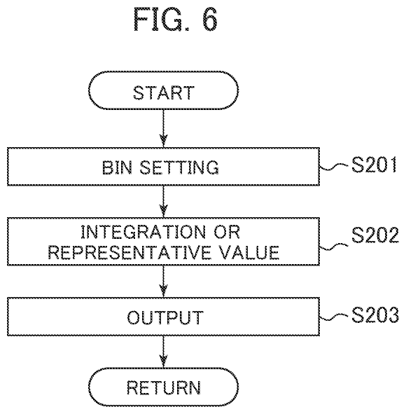

FIG. 6 is a flowchart that shows the binning processing steps which are performed in the first embodiment. The steps shown in FIG. 6 are performed by the binning processing unit 102 (see FIG. 1) and are detailed steps of Step S2 in FIG. 5.

As explained earlier in reference to FIG. 1, the binning processing unit 102 performs binning processing of signal charge data and outputs signal charge integration data.

In the following explanation, reference will be made to FIG. 1 to FIG. 4B as necessary.

First, the binning processing unit 102 separates the signal charge data in the wavelength direction according to the binning pattern stored in the storage device 113 (see FIG. 2) to set a bin 400 (S201). Specifically, the binning processing unit 102 performs binning of a given number of adjacent CCD pixels 301 according to the default binning pattern (combining pixel data into one bin 400). For example, as shown in FIG. 4A, the binning processing unit 102 groups a plurality of CCD pixels 301 into a bin 400 according to the default binning pattern. In the binning pattern which is first applied to the binning processing unit 102, the separated area size does not matter. For example, CCD pixels 301 may be separated one by one and the separation interval need not be regular. However, it is desirable to set the default binning pattern so that the number of CCD pixels 301 constituting a bin 400 can be adjusted in the binning adjustment process which will be explained later.

Next, the binning processing unit 102 integrates the signal values of the CCD pixels 301 constituting the bin 400 separated at Step S201 to set a bin 400 or determines a representative value of the signal values (S202). The method of determining a representative value includes calculation of an average value, central value, maximum value, or minimum value.

For example, in calculation of an average value, the binning processing unit 102 calculates the average value of the signal values of the CCD pixels 301 of each bin 400. In calculation of a central value, the binning processing unit 102 calculates the central value of the signal values of the CCD pixels 301 of each bin 400. In calculation of a minimum value or maximum value, the binning processing unit 102 calculates the maximum value or minimum value of the signal values of the CCD pixels 301 of each bin 400.

In the example shown in FIG. 3 and FIG. 4A, the signal value of each of the CCD pixels 301 constituting each bin 400 should be the same, but actually there is a variation. In this case, the binning processing unit 102 may calculate the average value, central value, maximum value or minimum value of CCD pixels 301 constituting each bin 400. The user can decide whether to integrate the signal values or determine a representative value for each bin 400.

The process at Step S202 corresponds to the process shown in FIG. 4B. The example shown in FIG. 4A and FIG. 4B is an example in which integration is performed at Step S202 (the signal values in FIG. 4A are integrated as shown in FIG. 4B). In this embodiment, it is assumed that integration is performed at Step S202.

In this way, the binning processing unit 102 calculates the integrated value or representative value of signal values (values of pixel data) of a given number of adjacent CCD pixels 301 and takes the calculated integrated value or representative value as a bin value (signal charge integrated value in this embodiment) to combine the given number of adjacent CCD pixels 301 into one bin. In this embodiment, the binning processing unit 102 calculates the signal charge integrated value as the integrated value of signal values (values of pixel data) of CCD pixels 301 in each bin 400.

After that, the binning processing unit 102 outputs the signal charge integrated value which is integrated at Step S202 (or the representative value), as signal charge integration data to the color conversion matrix calculation processing unit 103 and the color conversion processing unit 104 (S203).

Then, the electrophoresis data processing device 1 returns the process to Step S3 in FIG. 5.

### [Color Conversion Matrix Calculation Processing]

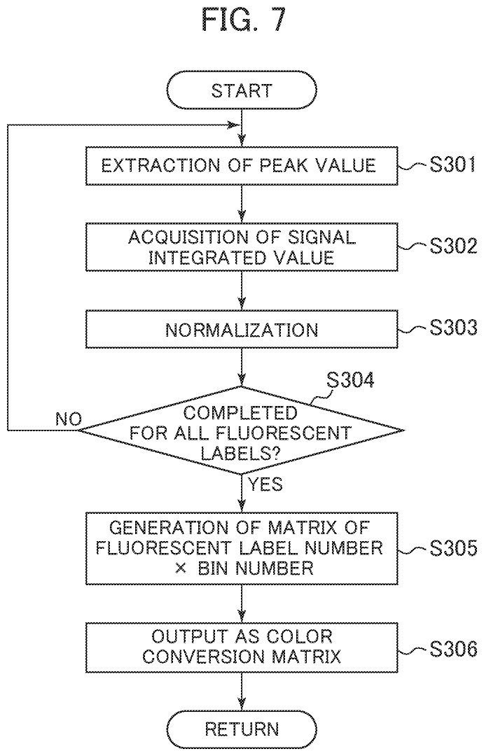

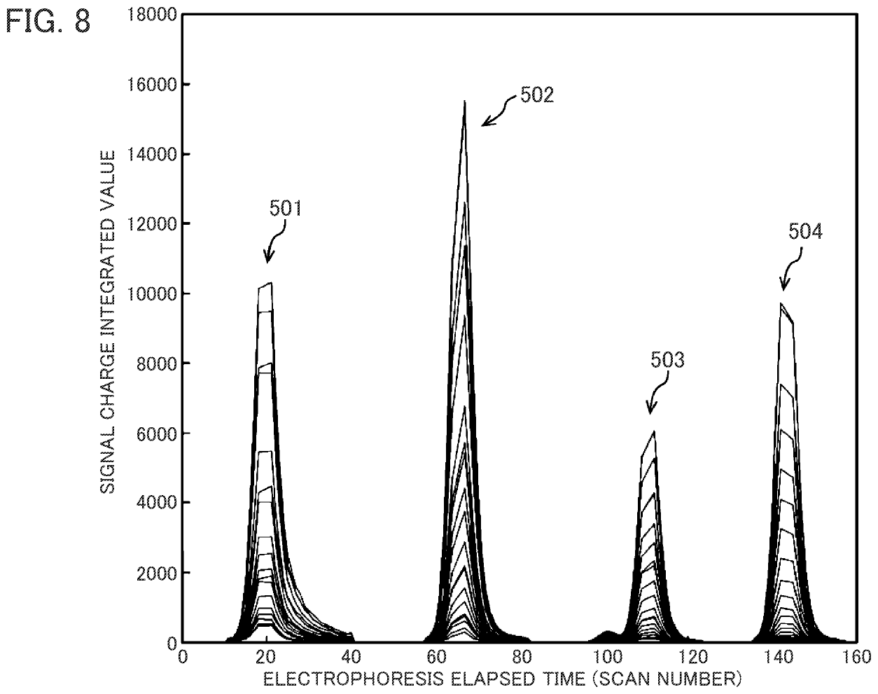

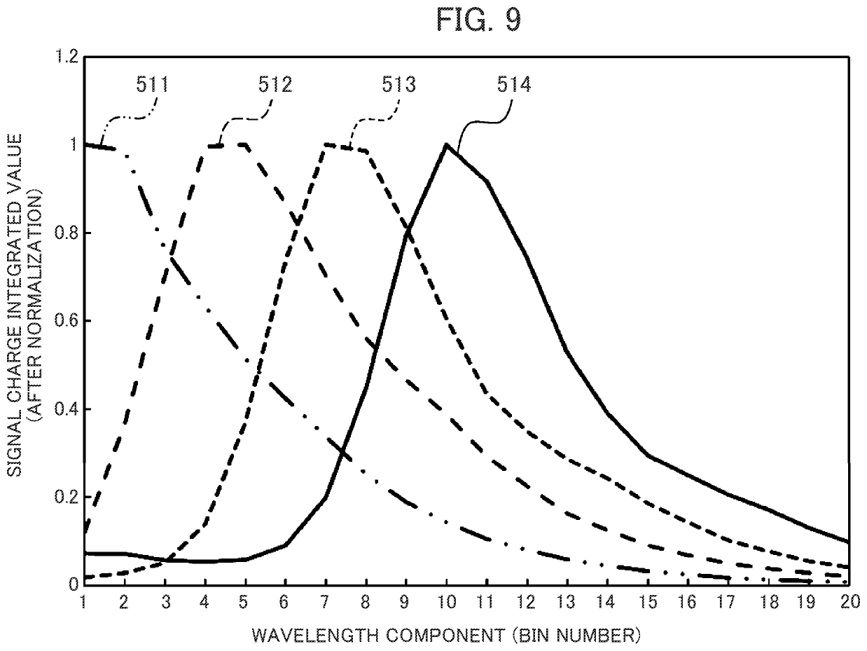

FIG. 7 is a flowchart that shows the color conversion matrix calculation processing steps which are performed in the first embodiment. The steps shown in FIG. 7 are performed by the color conversion matrix calculation processing unit 103 (bin value extraction unit) in FIG. 1 and FIG. 7 shows detailed steps of Step S3 in FIG. 5. Concrete examples of the steps shown in FIG. 7 will be later explained referring to FIG. 8 and FIG. 9.

In color conversion matrix calculation processing, the color conversion matrix calculation processing unit 103 calculates color conversion matrix [C] from signal charge integration data as described above in reference to FIG. 1. Color conversion matrix [C] is calculated from signal charge integration data with a peak which relates to only a specific fluorescent label. Color conversion matrix [C] will be explained later.

First, the color conversion matrix calculation processing unit 103 extracts a peak (second peak) position specific to the fluorescent label in the signal charge integration data (S301). In other words, the color conversion matrix calculation processing unit 103 extracts a peak (second peak) specific to the florescent label in the signal charge integration data. In short, the color conversion matrix calculation processing unit 103 extracts the peak specific to the fluorescent label (second peak as a peak corresponding to the fluorescent label) from the time series of signal charge integrated values.

Next, the color conversion matrix calculation processing unit 103 acquires the signal charge integrated value of each CCD division area (bin 400) constituting a peak (S302). In short, for each peak specific to the fluorescent label (second peak), the color conversion matrix calculation processing unit 103 extracts the signal charge integrated value which constitutes the peak specific to the fluorescent label (second peak).

Then, the color conversion matrix calculation processing unit 103 normalizes the acquired signal charge integrated value of each wavelength component (S303). The normalization procedure will be explained later.

Then, the color conversion matrix calculation processing unit 103 decides whether Steps S301 to S303 are completed for all the fluorescent labels or not (S304).

If Steps S301 to S303 are not completed for all the fluorescent labels (S304→No), the color conversion matrix calculation processing unit 103 returns the process to Step S301. Then, the color conversion matrix calculation processing unit 103 carries out Steps S301 to S303 for the fluorescent labels for which Steps S301 to S303 are not carried out.

On the other hand, if Steps S301 to S303 are completed for all the fluorescent labels (S304→Yes), the color conversion matrix calculation processing unit 103 generates normalized wavelength components as a matrix of the number of fluorescent labels×the number of bins (S305).

Then, the color conversion matrix calculation processing unit 103 outputs the matrix generated at Step S305 as a color conversion matrix C to the color conversion processing unit 104 (S306).

Then, the electrophoresis data processing device 1 returns the process to Step S4 in FIG. 5.

FIG. 8 shows an example of signal charge integration data. FIG. 8 shows an example of signal charge integration data that the color conversion matrix calculation processing unit 103 has acquired from the binning processing unit 102.

In FIG. 8, the horizonal axis denotes elapsed time of electrophoresis (actually, the number of scans (Scan number)) and the vertical axis denotes signal charge integrated value. In short, as shown in FIG. 8, signal charge integration data is time-series data of signal charge integrated values.

In addition, peaks 501 to 504 shown in FIG. 8 indicate peaks corresponding to respective fluorescent labels. This embodiment assumes that four fluorescent labels are used, as shown in FIG. 8. The four fluorescent labels are described here as the first fluorescent label, second fluorescent label, third fluorescent label, and fourth fluorescent label. The first fluorescent label corresponds to peak 501 and the second fluorescent label corresponds to peak 502. Similarly, the third fluorescent label corresponds to peak 503 and the fourth fluorescent label corresponds to peak 504. Peaks 501 to 504 are second peaks as mentioned above. In this way, the color conversion matrix calculation processing unit 103 extracts peaks 501 to 504 (second peaks) corresponding to the fluorescent labels from the time series of signal charge integrated values.

In FIG. 8, the plurality of lines shown in peaks 501 to 504 represent the signal charge integrated values in the respective bins 400. Thus, peaks 501 to 504 each indicate a set of signal charge integrated values (bin values) derived from a fluorescent label, which is extracted for each fluorescent label.

For example, as shown in FIG. 8, when signal charge integration data including four fluorescent labels are used, the color conversion matrix calculation processing unit 103 extracts signal charge integrated values of 20 bins 400 which constitute peaks 501 to 504 of the fluorescent labels (signal charge integrated values constituting the second peaks) respectively. In short, the color conversion matrix calculation processing unit 103 extracts the signal charge integrated values constituting peaks 501 to 504 (second peaks) for peaks 501 to 504 (second peaks). This process corresponds to Step S302 in FIG. 7. Detection of peaks 501 to 504 is Step S301 in FIG. 7.

After that, the color conversion matrix calculation processing unit 103 normalizes the signal charge integrated value as [0, 1] by dividing the signal charge integrated value of each of 20 bins 400 by the maximum signal charge integrated value. Normalization is performed for each of peaks 501 to 504. This process corresponds to Step S303 in FIG. 7.

The color conversion matrix calculation processing unit 103 performs extraction and normalization of peaks 501 to 504 for each of the four fluorescent labels (Step S304 in FIG. 7). By doing so, the color conversion matrix calculation processing unit 103 extracts a set of signal charge integrated values (bin values) derived from a fluorescent label for each fluorescent label.

FIG. 9 shows the result of peak extraction and normalization which have been performed for the four fluorescent labels.

FIG. 9 shows spectrum 511 to spectrum 514 obtained by plotting in which the horizontal axis denotes wavelength component (bin number) and the vertical axis denotes a signal charge integrated value after normalization. Spectrum 511 to spectrum 514 correspond to the four fluorescent labels respectively. The color conversion matrix calculation processing unit 103 generates (calculates) the spectrum 511 to spectrum 514 shown in FIG. 9, as color conversion matrix [C] (conversion matrix) which is a matrix of the number of fluorescent labels (4 in the example shown in FIG. 9) by the number of bins in the wavelength direction (20 in this embodiment), namely a matrix with 4×20 components (which corresponds to Steps S305 and S306 in FIG. 7). The color conversion matrix calculation processing unit 103 stores the generated color conversion matrix [C] in the storage unit. In short, the color conversion matrix [C] is a matrix in which the extracted peaks 501 to 504 (second peaks) are the components for a row and bins 400 are the components for a column and the signal charge integrated values are individual component values. In this embodiment, a capital alphabetic letter in brackets, like [C], indicates a matrix (brackets are omitted in a calculating expression). Spectrum 511 to spectrum 514 each correspond to a set of signal charge integrated values (bin values) derived from a fluorescent label, which is extracted from each fluorescent label.

### [Color Conversion Processing]

Next, color conversion processing by the color conversion processing unit 104 (signal intensity calculation unit) will be described.

The color conversion processing unit 104 converts the signal charge integration data into fluorescent color signal data derived from each fluorescent label which is included in the sample, using the color conversion matrix [C] calculated by processing shown in FIG. 7.

Concretely, the color conversion processing unit 104 generates fluorescent color signal data with the following procedure.

In addition, a signal charge integration matrix is expressed as [F] (matrix of scan number×bin number). The signal charge integration matrix [F] is a matrix of scan number×bin number which is obtained from the signal charge integration data shown in FIG. 8. In short, the signal charge integration matrix [F] is a matrix which has the signal charge integrated values as individual component values where the scan number is the component for a row and bin 400 is the component for a column in the time series of signal charge integrated values.

It is assumed here that the color conversion matrix is a matrix expressed as [C] (fluorescent label number×bin number) (set of extracted bin values) and fluorescent color signal data which will be generated is a matrix expressed as [P] (scan number×color number). Then, the following equations (1) and (2) should be satisfied. As indicated by equation (2), the color conversion processing unit 104 calculates an inverse matrix of the color conversion matrix [C] (conversion matrix) and calculates signal component [P] derived from each fluorescent label by multiplying [F] by the calculated color conversion matrix [C] from the right.

$$F = PC \qquad ( 1 )$$

$$F {C}^{- 1} = P C {C}^{- 1} = P \qquad ( 2 )$$

However, if the color conversion matrix [C] and signal charge integration matrix [F] are each defined as a transposed matrix, the signal component [P] derived from the fluorescent label is calculated by multiplying [F] by the inverse matrix of the color conversion matrix [C] from the left.

The signal component [P] derived from the fluorescent label thus calculated has the signal intensity time series of each fluorescent label as its component. In short, the color conversion processing unit 104 acquires the signal intensity time series of each fluorescent label by calculation of equation (2). By doing so, the color conversion processing unit 104 calculates the signal intensity of each fluorescent label based on the signal data integration data (set of extracted bin values).

### [Flowchart]

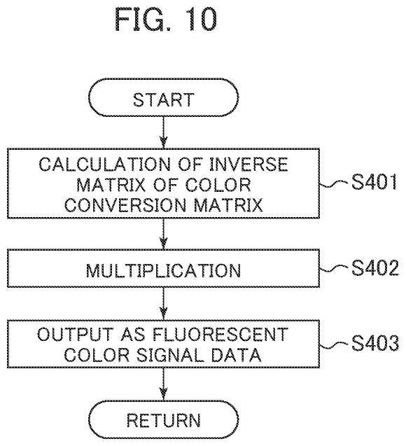

Next, color conversion processing which is performed by the color conversion processing unit 104 will be explained referring to FIG. 10.

FIG. 10 is a flowchart that shows the color conversion processing steps which are performed in the first embodiment. The steps shown in FIG. 10 are detailed steps of Step S4 in FIG. 5.

First, the color conversion processing unit 104 calculates an inverse matrix (equation (2)) of the color conversion matrix [C] ([C⁻¹] of equation (2)) (S401). In connection with the number of matrix elements, a pseudo inverse matrix may be used instead of an inverse matrix.

Next, for the color conversion matrix, the signal component [P] derived from the fluorescent label (signal charge integration data) is multiplied by the inverse matrix of the color conversion matrix [C] from the right (S402). This step corresponds to the above equation (2).

Then, the color conversion processing unit 104 outputs the data calculated at Step S402 (signal component [P] derived from the fluorescent label of equation (2)) as fluorescent color signal data to the color signal evaluation processing unit 105 (S403).

Then, the electrophoresis data processing device 1 returns the process to Step S5 in FIG. 5.

### (Fluorescent Color Signal Data)

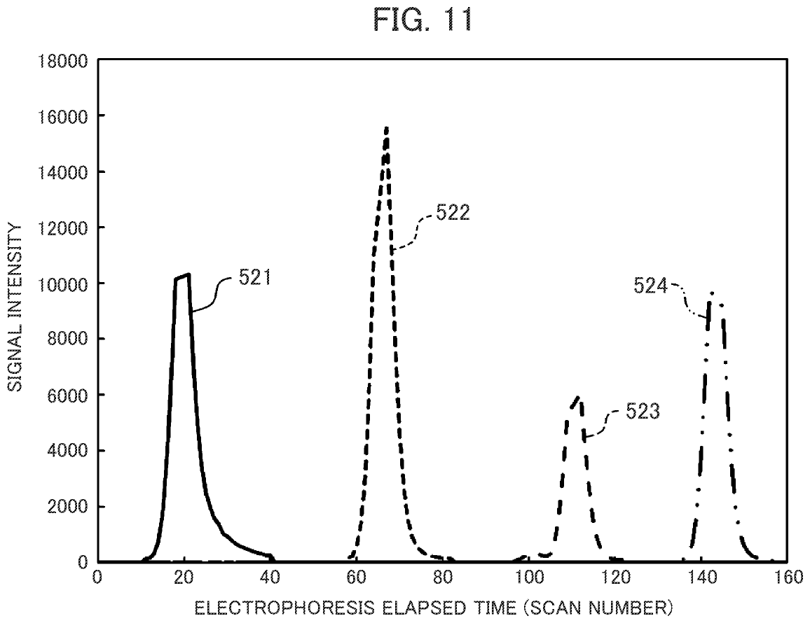

FIG. 11 is a graph that shows an example of fluorescent color signal data.

In FIG. 11, the horizontal axis denotes elapsed time of electrophoresis (actually, scan number (Scan Number)) and the vertical axis denotes signal intensity. FIG. 11 shows the matrix [P] of signal components derived from a fluorescent label as indicated by equation (2) in the form of a graph. Unlike FIG. 8, the signal intensity in FIG. 11 is expressed as the relation between time and signal intensity without information on bins 400. In this embodiment, the information on CCD pixel 301 is called “signal value”, information on bin 400 is called “signal charge integrated value” and information on fluorescent color signal data shown in FIG. 11 is called “signal intensity”.

As shown in FIG. 11, the matrix [P] of signal components derived from the fluorescent labels has information on signal intensities 521 to 524 as signal intensities derived from the respective fluorescent labels.

### [Fluorescent Color Signal Evaluated Value Calculation Processing]

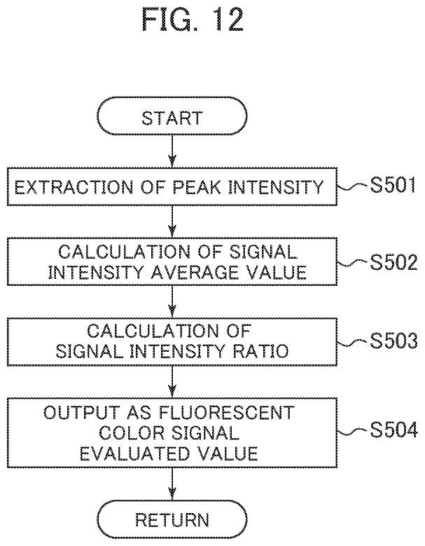

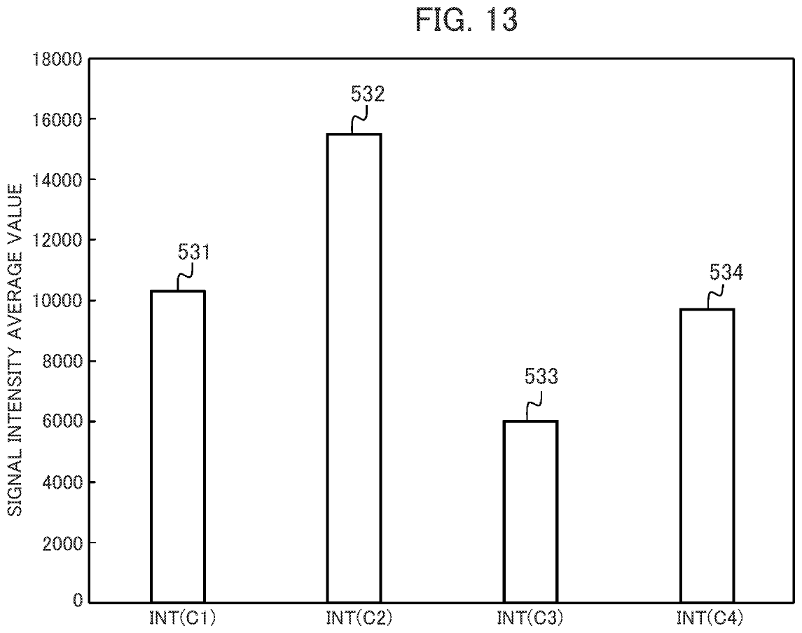

Next, fluorescent color signal evaluated value calculation processing by the color signal evaluation processing unit 105 will be explained referring to FIG. 12 and FIG. 13.

The color signal evaluation processing unit 105 calculates the fluorescent color signal evaluated value from fluorescent color signal data as mentioned above in reference to FIG. 1.

### (Flowchart)

FIG. 12 is a flowchart that shows the fluorescent color signal evaluated value calculation processing steps which are performed in the first embodiment. FIG. 12 shows detailed steps of Step S5 in FIG. 5.

First, the color signal evaluation processing unit 105 extracts the peak intensity derived from each fluorescent label from the fluorescent color signal data (S501). As mentioned earlier, the fluorescent color signal data means the matrix [P] of signal components derived from a fluorescent label as calculated by equation (2) and is as shown in FIG. 11. The peak intensity means the peak value of signal intensity derived from each fluorescent label. In extracting the peak intensity, the color signal evaluation processing unit 105 uses the fluorescent color signal data obtained using a sample in which the fluorescent label molecular weight forming the peak in each fluorescent label is previously known to be equal or almost equal. In short, the peak is estimated using the sample in which the fluorescent label molecular weight forming the peak in each fluorescent label is previously known to be equal or almost equal and the peak intensity is extracted.

Next, the color signal evaluation processing unit 105 calculates the signal intensity average values (value of the first peak as the signal intensity peak, value of the signal intensity peak) of signal intensities 521 to 524 (see FIG. 11) derived from the respective fluorescent labels (S502). For example, the signal intensity average value of the signal peak derived from the first fluorescent label is expressed as INT (P1). Similarly, the values for the second fluorescent label, the third fluorescent label, and the fourth fluorescent label are expressed as INT (P2), INT (P3) and INT (P4), respectively. For example, the color signal evaluation processing unit 105 calculates the average value of signal intensity 521 in FIG. 11 as INT (P1). Similarly, the color signal evaluation processing unit 105 calculates the average values of signals 522 to 524 in FIG. 11 as INT (P2) to INT (P4).

Then, the color signal evaluation processing unit 105 extracts the largest value among INT (P1) to INT (P4) and the smallest value as INT (Max) and INT (Min) respectively.

Then, the color signal evaluation processing unit 105 calculates the signal intensity ratio×expressed by the following equation (3) using the extracted feature.

$$X = INT ( Min ) / INT ( Max ) \qquad ( 3 )$$

After that, the color signal evaluation processing unit 105 outputs the signal intensity ratio×calculated at Step S503 as the fluorescent color signal evaluated value (evaluated value, first evaluated value) (S504). The fluorescent color signal evaluated value thus calculated is an evaluated value that indicates the degree of variation in signal intensities 521 to 524 shown in FIG. 11.

Then, the electrophoresis data processing device 1 returns the process to Step S6 in FIG. 5.

For example, FIG. 13 shows the signal intensity average values calculated based on the fluorescent color signal data shown in FIG. 11.

FIG. 13 is a graph that shows an example of signal intensity average values.

FIG. 13 shows the processing result at Step S502 in FIG. 12.

The signal intensity average value 531 shown in FIG. 13 is the signal intensity average value derived from the first fluorescent label (INT (P1)=[10300]). The signal intensity average value 532 is the signal intensity average value derived from the second fluorescent label (INT (P2)=[15500]). The signal intensity average value 533 is the signal intensity average value derived from the third fluorescent label (INT (P3)=[6000]). The signal intensity average value 534 is the signal intensity average value derived from the fourth fluorescent label (INT (P4)=[9700]). Processing to calculate the signal intensity average values 531 to 534 in this way corresponds to Step S502 in FIG. 12.

According to the signal intensity average values shown in FIG. 13, INT (Max) is INT (P2) (signal intensity average value 522)=15500 and INT (Min) is INT (P3) (signal intensity average value 523)=6000. Therefore, the signal intensity ratio X is 6000/15500=0.39. This process corresponds to Step S503 in FIG. 12. As mentioned above, the color signal evaluation processing unit 105 outputs the calculated signal intensity ratio X as the fluorescent color signal evaluated value (Step S504 in FIG. 12).

### [Decision Processing]

Next, decision processing by the decision processing unit 106 at Step S6 in FIG. 5 will be explained.

The decision processing unit 106 decides whether the next step should be binning area adjustment processing (Step S7 in FIG. 5) or binning pattern output processing (Step S8 in FIG. 5). If the fluorescent color signal evaluated value (signal intensity ratio X) is less than a prescribed threshold (S6→No: the prescribed condition is satisfied), the current binning pattern is decided to be not optimal and the next step is binning area adjustment processing (Step S7 in FIG. 5). On the other hand, if the fluorescent color signal evaluated value is not less than the prescribed threshold (S6→Yes: the prescribed condition is not satisfied), the current binning pattern is decided to be optimal and the next step is binning pattern output processing (Step S8 in FIG. 5).

### [Binning Area Adjustment Processing]

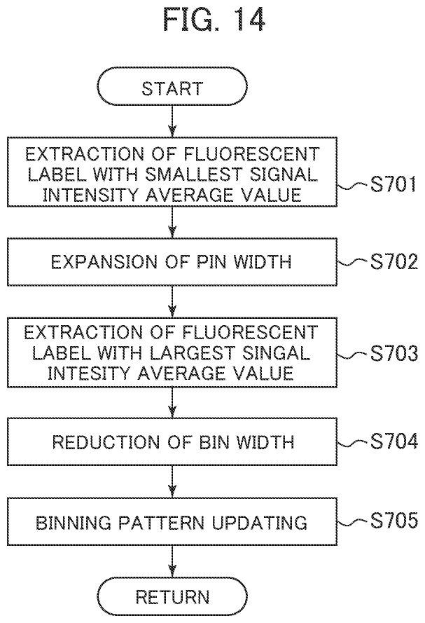

Next, binning area adjustment processing by the binning area adjustment processing unit 107 will be explained referring to FIG. 14.

The binning area adjustment processing unit 107 adjusts the binning pattern to divide the wavelength band. The binning area adjustment processing unit 107 uses the signal intensity average value used to calculate the fluorescent color signal evaluated value (FIG. 13), the relation between fluorescent wavelength distribution and bin 400 as shown in FIG. 4A, the signal charge integrated value after normalization as shown in FIG. 9 and so on.

### [Flowchart]

FIG. 14 is a flowchart that shows the binning area adjustment processing steps. The steps shown in FIG. 14 are detailed steps of Step S7 in FIG. 5.

First, the binning area adjustment processing unit 107 extracts the fluorescent label whose signal intensity average value of fluorescent color signal data (value of the first peak, value of signal intensity peak) is the minimum (smallest) (S701). In the example of fluorescent color signal data shown in FIG. 13, the signal intensity average value 533 (INT (P3)), namely the third fluorescent label is extracted.

Next, the binning area adjustment processing unit 107 performs bin width expansion processing to expand the bin width (size of bin 400) so as to enlarge the area corresponding to the wavelength to strengthen the fluorescent label extracted at Step 701 (S702). In short, the binning area adjustment processing unit 107 expands the bin width so as to increase the peak signal charge integrated value for the fluorescent label extracted at S701.

For example, the binning area adjustment processing unit 107 expands the width of the bin 400 corresponding to the peak top part (the maximum bin value as the largest bin value among the set of bin values) of the third fluorescent label (spectrum 513) in FIG. 9 by 10% to 80%. Furthermore, the binning area adjustment processing unit 107 reduces the width of the bin 400 adjacent to the expanded bin 400. This suppresses the influence of width expansion of the bin 400 on the other bins 400.

In FIG. 9, in the spectrum 513 after normalization which corresponds to the third fluorescent label, bin number “7” is the peak. Therefore, at Step S702, the binning area adjustment processing unit 107 expands the bin width of the bin 400 with bin number “7”. Such bin width expansion is also applied to the other fluorescent labels.

Next, the binning area adjustment processing unit 107 extracts the fluorescent label whose signal intensity average value of fluorescent color signal data (value of the first peak) is the maximum (largest) (S703). In the example of fluorescent color signal data shown in FIG. 13, the signal intensity average value 532 (INT (P2)), namely the second fluorescent label is extracted.

Then, the binning area adjustment processing unit 107 performs bin width reduction processing to reduce the bin width (size of bin 400) so as to decrease the area corresponding to the wavelength to strengthen the extracted fluorescent label (S704). In short, the binning area adjustment processing unit 107 reduces the bin width so as to decrease the peak signal charge integrated value for the fluorescent label extracted at S703.

For example, the binning area adjustment processing unit 107 reduces the bin number corresponding to the peak top part (the maximum bin value) of the second fluorescent label (spectrum 512) in FIG. 9 by 10% to 80%. Furthermore, the binning area adjustment processing unit 107 expands the width of the bin 400 adjacent to the reduced bin 400. This suppresses the influence of width expansion of the bin 400 on the other bins 400.

In the example shown in FIG. 9, in the spectrum 512 after normalization which corresponds to the second fluorescent label, bin number “5” is the peak. Therefore, at Step S704, the binning area adjustment processing unit 107 reduces the bin width of the bin 400 with bin number “5”. Such bin width reduction is also applied to the other fluorescent labels.

The binning area adjustment processing unit 107 may reduce the bin width so as not to acquire part of the area corresponding to the wavelength to strengthen the extracted fluorescent label in S704. In other words, reduction of bin 400 width may include deletion of a bin 400. For example, the bin 400 belonging to the peak top part may remain and a bin 400 adjacent to the peak top part may be deleted. This suppresses the influence of bin 400 width expansion on the other bins 400.

Then, the binning area adjustment processing unit 107 generates the binning pattern reflecting the adjusted bin width as the second binning pattern. As the binning area adjustment processing unit 107 takes the binning pattern before bin width adjustment as the first binning pattern, it updates the first binning pattern with the second binning pattern (binning pattern updating: S705).

The electrophoresis data processing device 1 repeats Steps S2 to S6 in FIG. 5 using the updated binning pattern (second binning pattern). The repetition is continued until the decision processing unit 106 decides that the fluorescent color signal evaluated value is not less than the prescribed threshold. Finally, when the decision processing unit 106 decides that the fluorescent color signal evaluated value is not less than the prescribed threshold, the binning pattern output unit 108 outputs the final binning pattern to the outside (Step S8 in FIG. 5).

### [Operation Screens]

Hereinafter, the screens displayed in the first embodiment will be explained referring to FIG. 2 as necessary. The screens 600, 610, and 620 shown in FIG. 15A to FIG. 15D are the screens displayed at Step S0 in FIG. 2.

FIG. 15A shows an example of the menu screen 600.

As shown in FIG. 15A, the menu screen 600 has an analysis start button 601 (electrophoresis start button as a button to start electrophoresis by the electrophoresis device), an analysis sample set button 602, a fluorescence sensitivity adjustment button 603 (sensitivity adjustment start button as a button to adjust the sensitivity for each fluorescent label), and a maintenance button 604.

When the analysis start button 601 is selected through the input device 114, analysis of the sample by electrophoresis is started.

The analysis sample set button 602 is a button to set the sample.

When the fluorescence sensitivity adjustment button 603 displayed separately from the analysis start button 601 is selected through the input device 114, processing by the binning processing unit 102 to the binning area adjustment processing unit 107 is started.

The maintenance button 604 is a button which is selected to perform maintenance of the electrophoresis device 2.

In FIG. 15A, a mouse cursor M indicates a case that the analysis start button 601 is selected through the input device 114 (see FIG. 2) while fluorescence sensitivity adjustment is not completed. Fluorescent color signal data in which the fluorescent label intensity varies among the fluorescent labels as shown in FIG. 11 is acquired. The condition in which fluorescence sensitivity adjustment is not completed means a condition that the fluorescence sensitivity adjustment button 603 is not selected and processing by the binning processing unit 102 to the binning area adjustment processing unit 107 is not started (before processing by the bin generating unit, signal sensitivity calculation unit and adjustment unit is performed).

When the analysis start button 601 is selected through the input device 114 while fluorescence sensitivity adjustment is not completed, a dialog screen 610 which gives a warning and urges fluorescence sensitivity adjustment (message to urge processing by the bin generating unit, signal sensitivity calculation unit and adjustment unit) appears as shown in FIG. 15B.

As shown in FIG. 15B, the dialog screen 610 displays a YES button 611 and a NO button 612.

As the YES button 611 is selected through the input device 114 on the dialog screen 610, analysis of the sample by electrophoresis is started.

As the NO button 611 is selected through the input device 114 on the dialog screen 610 (indicated by the mouse cursor M in FIG. 15B), the menu screen 600 shown in FIG. 15A returns.

FIG. 15C shows the menu screen 600 which indicates that the fluorescence sensitivity adjustment button is selected through the input device 114 (indicated by the mouse cursor M in FIG. 15C).

Since the menu screen 600 shown in FIG. 15C is the same as the one shown in FIG. 15A, the same reference signs as in FIG. 15A are used in FIG. 15C and its description is omitted.

As shown in FIG. 15C, when the fluorescence sensitivity adjustment button 603 is selected (selection of the fluorescence sensitivity adjustment button 603 through the input unit), a fluorescence sensitivity adjustment screen 620 as shown in FIG. 15D appears.

The fluorescence sensitivity adjustment screen 620 displays a sample content input window 621 and a set confirmation button 622. The sample content input window 621 enables the user to enter the type of adjustment sample through the input device 114 or select through a pulldown menu (not shown). The adjustment sample means DNA molecules to which a plurality of fluorescent labels are given. After the adjustment sample is set in the electrophoresis device 2, the user selects the set confirmation button 622 associated with the sample content input window 621 for the set adjustment sample, through the input device 114.

After the sample required for fluorescence sensitivity adjustment is set in the electrophoresis device 2, the user selects the start button 623 and using the set adjustment sample, processing as shown in FIG. 5 is started. In this way, Step S1 and subsequent steps in FIG. 5 are started by selection of the fluorescence sensitivity adjustment button 603 (sensitivity adjustment start button) through the input device 114 (input unit). In FIG. 15D, the mouse cursor M indicates that the user selects the start button 623.

As shown in FIG. 15D, two or more adjustment samples can be set.

The screens 610, 610 and 620 shown in FIG. 15A to FIG. 15D are displayed on the display device 115 (see FIG. 2) by the input/output processing unit 109 (see FIG. 1). The input/output processing unit 109 acquires the information entered through the input device 114 (see FIG. 2). In other words, when the input/output processing unit 109 acquires an instruction to start sensitivity adjustment by selection of the start button 623 shown in FIG. 15D (by selection of the sensitivity adjustment start button through the input unit), the input/output processing unit 109 instructs the signal charge data acquisition unit 101 (see FIG. 1) to start processing.

In the ordinary electrophoresis system Z, the fluorescence sensitivity adjustment button 603 as shown in FIG. 15A and FIG. 15C is not displayed on the menu screen 600. Also, in the ordinary electrophoresis system Z, the dialog screen 610 as shown in FIG. 15B and the fluorescence sensitivity adjustment screen 620 as shown in FIG. 15D are not displayed. Since the screens 600, 610 and 620 as shown in FIG. 15A to FIG. 15C are displayed, the user can easily perform the processing shown in FIG. 5.

### [Fluorescent Color Signal Data]

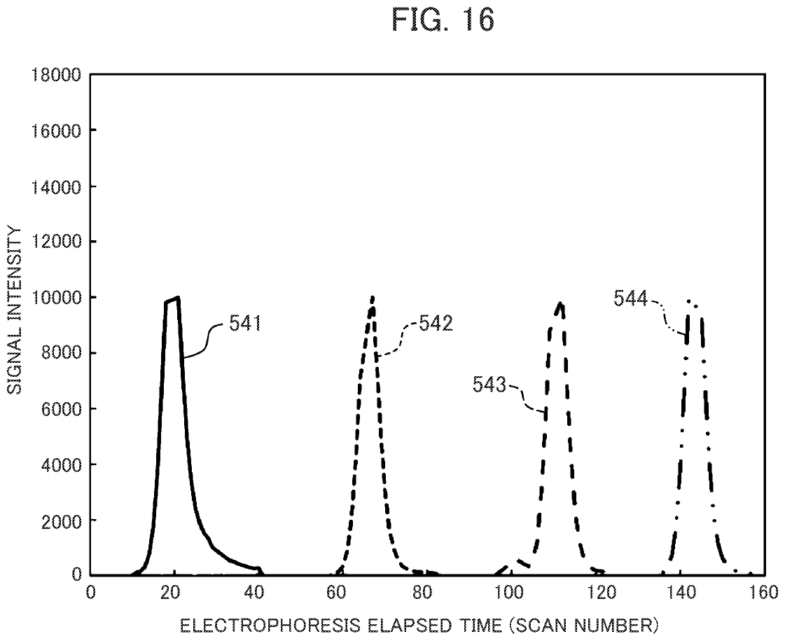

FIG. 16 is a graph that shows an example of fluorescent color signal data as the result of completion of sensitivity adjustment processing according to this embodiment.

FIG. 16 shows the fluorescent color signal data finally displayed on the display device 115 when the analysis start button 601 shown in FIG. 15A and FIG. 15C is selected after completion of fluorescence sensitivity adjustment.

The horizontal axis and vertical axis in FIG. 16 are the same as in FIG. 11 and their description is omitted.

The signal intensities 541 to 544 shown in FIG. 16 indicate the signal intensities of the fluorescent labels corresponding to the signal intensities 521 to 524 shown in FIG. 11.

As compared with the signal intensities 521 to 524 shown in FIG. 11, the signal intensities 541 to 544 are almost the same.

As in the technique described in Patent Literature 1, the amount of data can be decreased by binning at regular intervals. However, since the wavelength characteristics are different among fluorescent labels, even if the fluorescent labels have the same density ratio, variation arises in the intensity of fluorescent color separation signals. If this variation is large, the fluorescent label density range which can be detected is narrow. For this reason, it is necessary to adjust the binning pattern adequately and the adjustment for an adequate binning pattern has been made manually in the past.

According to the first embodiment, the electrophoresis data processing device 1 searches the most suitable binning pattern to suppress the variation in the signal intensity, based on the signal values of CCD pixels 301, and outputs it. This reduces the burden on the user and ensures that the signal intensity with reduced variation is acquired.

In other words, the electrophoresis system Z according to the first embodiment makes it possible to acquire fluorescent color signal data with reduced variation in the signal intensity among the fluorescent labels.

As shown in FIG. 5, Steps S2 to S7 are repeated until “Yes” is decided at Step S6. By doing so, whatever the default binning pattern is, the binning pattern most suitable to reduce the signal intensity variation can be obtained finally.

Therefore, according to this embodiment, the effective binning pattern for the set of fluorescent labels in use can be calculated accurately and as quickly as possible and the variation in sensitivity among the fluorescent labels can be suppressed.

Even if the bins 400 are adjusted to improve the S/N ratio as in the techniques described in Patent Literature 2 and 3, variation in the signal intensity among fluorescent labels may occur. If variation in the signal intensity among fluorescent labels occurs, unfavorably the data analysis result also varies. In this embodiment, priority is given to suppression of variation in the signal intensity among fluorescent labels over improvement of S/N ratio. By doing so, variation in the data analysis result can be suppressed and data analysis can be made with higher accuracy than simply by improvement of S/N ratio.

### Second Embodiment

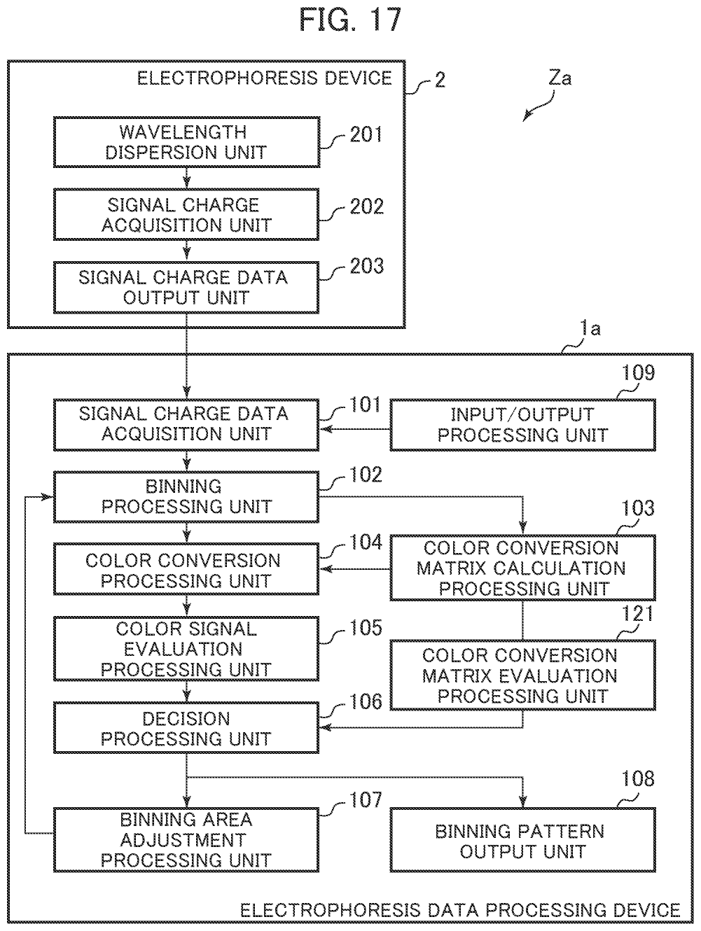

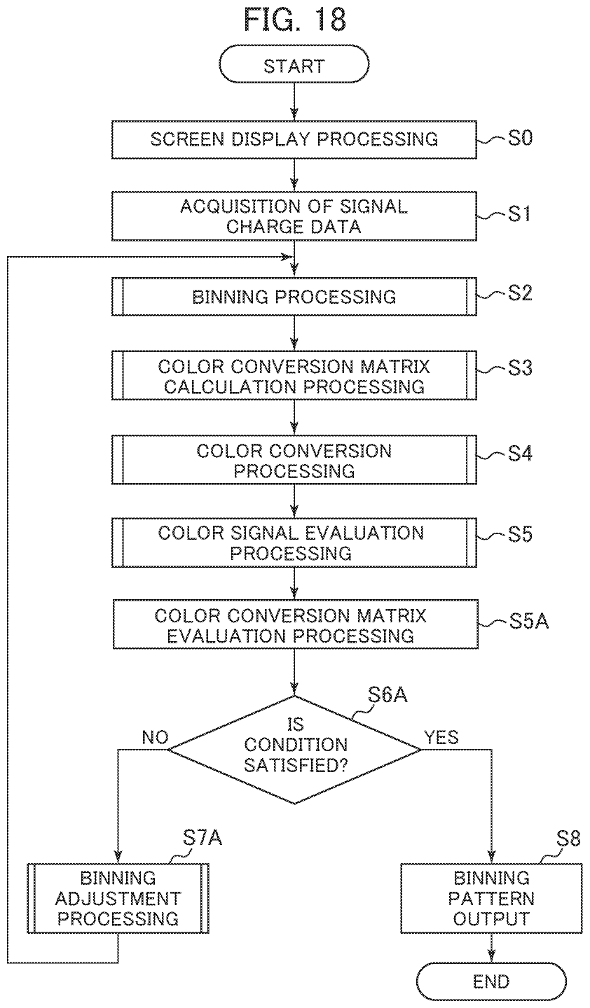

Next, the second embodiment of the present invention will be described referring to FIG. 17 and FIG. 18.

### [System Configuration]

FIG. 17 shows an example of the configuration of the electrophoresis system Za according to the second embodiment.

In FIG. 17, the same elements as in FIG. 1 are designated by the same reference signs and their description is omitted.

FIG. 17 is different from FIG. 1 in that a color conversion matrix evaluation processing unit 121 is added to the electrophoresis data processing device 1a. What is performed by the color conversion matrix evaluation processing unit 121 will be explained later. The color conversion matrix evaluation processing unit 121 is embodied when the program stored in the storage deice 113 shown in FIG. 2 is loaded in the memory 111 and executed by the CPU 112.

### [Overall Process]

FIG. 18 is a flowchart that shows an example of electrophoresis data processing which is performed in the second embodiment.

In FIG. 18, the same steps as in FIG. 5 are designated by the same reference signs and their description is omitted.

FIG. 18 is different from FIG. 5 in that a color conversion matrix evaluation step (S5A) is added to Step S5. Step S5 will be explained later. Steps S6A and S7A will also be explained later.

### [Color Conversion Matrix Evaluation Processing]

Step S5A in FIG. 18 (color conversion matrix evaluation processing) is explained below.

The color conversion matrix evaluation processing unit 121 (second evaluation calculation unit) calculates a color conversion matrix evaluated value (second evaluated value) from the color conversion matrix [C] calculated by the color conversion matrix calculation processing unit 103. For the color conversion matrix evaluation equation value, for example, the condition number in color conversion matrix [C] can be used. When the color conversion matrix is [C], condition number k (C) in the color conversion matrix [C], namely the color conversion matrix evaluated value is calculated from the following equation (11) as a color conversion matrix evaluation equation. Needless to say, an index other than the condition number indicated by equation (4) may be used in the color conversion matrix evaluated value. ∥C∥ represents the squared norm value of C. This color conversion matrix evaluated value represents the calculation accuracy in calculating the signal component [P] derived from the fluorescent label in equation (2) (signal intensity of each fluorescent label). Thus, the color conversion matrix evaluation processing unit 121 calculates the color conversion matrix evaluated value (second evaluated value) which represents the calculation accuracy in calculating the signal component [P] derived from the fluorescent label (signal intensity of each fluorescent label) on the basis of the color conversion matrix [C] (conversion matrix).

$$k ( C ) = ‖ {C}^{- 1} ‖ \cdot ‖ C ‖ \qquad ( 11 )$$

The decision processing unit 106 decides at Step S6A in FIG. 18 whether the next step should be binning area adjustment processing (Step S7A in FIG. 18) or binning pattern output processing (Step S8 in FIG. 18), based on the fluorescent color signal evaluated value and the color conversion matrix evaluated value. If one of the fluorescent color signal evaluated value and the fluorescent color matrix evaluated value cannot meet a prescribed criterion (S6A-No in FIG. 18; the first evaluated value and the second evaluated value meet the prescribed condition), the next step is binning adjustment processing (Step S7A in FIG. 18). If the fluorescent color signal evaluated value and the color conversion matrix evaluated value both meet the criterion (S6A-Yes in FIG. 18), the next step is processing by the binning pattern output unit 108 (Step S8 in FIG. 18). The prescribed criterion may be, for example, “a prescribed threshold or less”.

At Step S7A in FIG. 18, the binning area adjustment processing unit 107 performs processing to make the calculation accuracy higher than the current calculation accuracy, in addition to the processing performed (bin adjustment) at Step S7 in FIG. 5. The processing to increase the calculation accuracy is that if calculation is currently made with single precision, it is changed to calculation with double precision.

In the second embodiment, the fluorescent color signal evaluated value and the color conversion matrix evaluated value are judged at the same time at Step S6A in FIG. 18, but instead the decision may be made by two steps. Specifically, if the fluorescent color signal evaluated value is not less than the prescribed threshold at Sep S6 (S6A→Yes), the decision processing unit 106 may decide whether or not the pullup evaluated value is not less than the prescribed threshold. If the color conversion matrix evaluated value is less than the prescribed threshold, the binning area adjustment unit 107 (adjustment unit) performs processing to make the calculation accuracy higher than the current calculation accuracy. After that, the electrophoresis data processing device 1 returns the process to Step S2.

On the other hand, if the color conversion matrix evaluated value is not less than the prescribed threshold, Step S8 is carried out.

According to the second embodiment, the decline in calculation accuracy can be suppressed.

### Third Embodiment

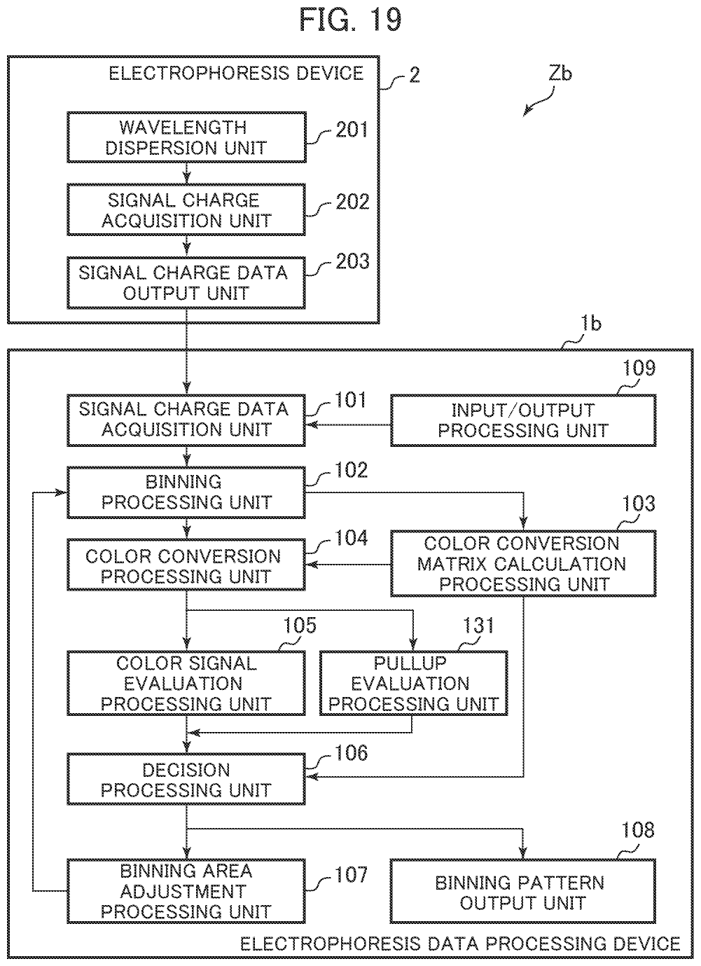

Next, the third embodiment of the present invention will be described referring to FIGS. 19 to 21.

### [System Configuration]

FIG. 19 shows an example of the configuration of the electrophoresis system Zb according to the third embodiment.

In FIG. 19, the same elements as in FIG. 1 are designated by the same reference signs and their description is omitted.

The electrophoresis system Zb shown in FIG. 19 is different from the electrophoresis system Z shown in FIG. 1 in that the electrophoresis data processing device 1b has a pullup evaluation processing unit 131. What is performed by the pullup evaluation processing unit 131 will be explained later. The pullup evaluation processing unit 131 is embodied when the program stored in the storage device 113 shown in FIG. 2 is loaded in the memory 111 and executed by the CPU 112.

### [Overall Process]

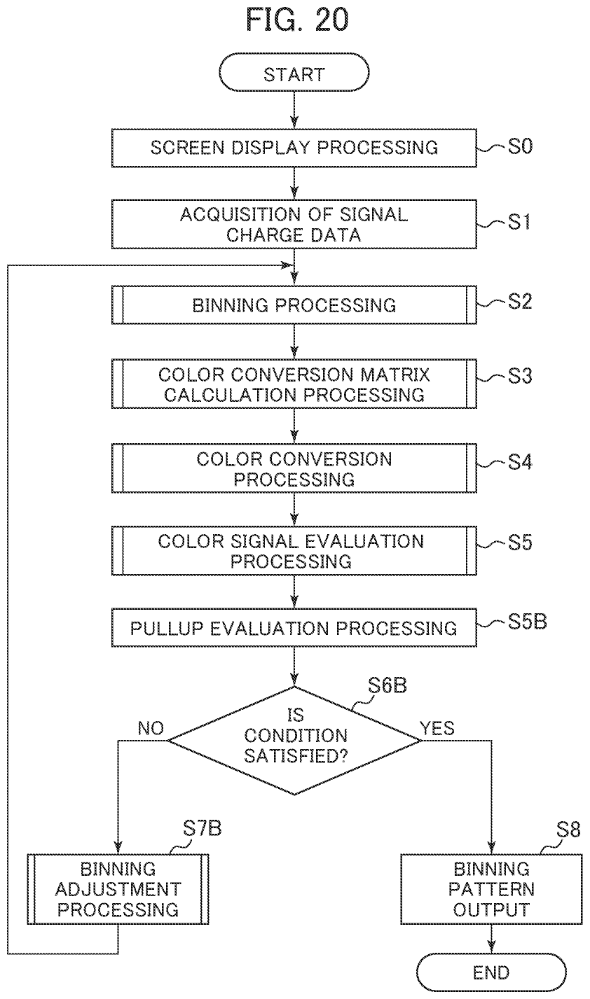

FIG. 20 is a flowchart that shows an example of electrophoresis data processing which is performed in the third embodiment.

In FIG. 20, the same steps as in FIG. 5 are designated by the same reference signs and their description is omitted.

The process shown in FIG. 20 is different from that in FIG. 5 in that a pullup evaluation step (S5B) is added after Step S5. Step S5B will be explained later. Steps S6B and S7B will be also explained later.

### [Pullup Evaluation Processing]

Step S5B in FIG. 20 (pullup evaluation processing) is explained below.

The pullup evaluation processing unit 131 calculates a pullup evaluated value (third evaluated value) from the fluorescent color signal data generated by the color conversion processing unit 104. In fluorescent color signal data, due to color conversion processing, the signal intensity of another fluorescent label may overlap the signal intensity of a specific fluorescent label. The signal intensity of the main fluorescent label is expressed as INT (Main). The signal intensity of the overlapping other (sub) fluorescent label is expressed as INT (Sub). In this case, the pullup evaluated value (Pullup) is expressed by the following equation (21)

$$Pullup = INT ( Sub ) / INT ( Main ) \qquad ( 5 )$$

### [Fluorescent Color Signal Data]

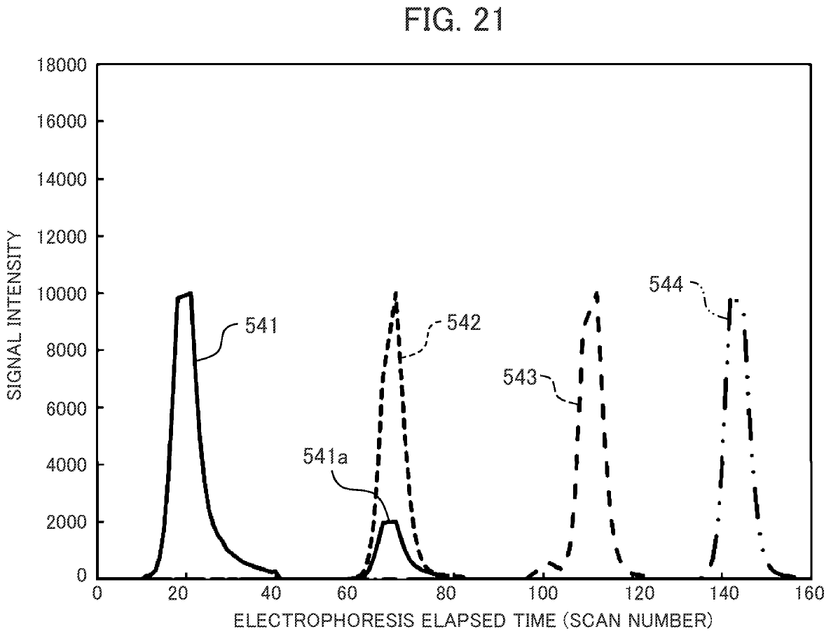

FIG. 21 shows an example of fluorescent color signal data in which pullup has occurred.

The horizontal axis and vertical axis shown in FIG. 21 are the same as the horizontal axis and vertical axis shown in FIG. 11 and their description is omitted.

Signal intensities 541 to 544 in FIG. 21 correspond to signal intensities 521 to 524 shown in FIG. 11. In FIG. 21, variation among the main signal intensities 541 to 544 has already been suppressed.

In FIG. 21, the signal intensity 541a of the first fluorescent label (signal intensity in the second fluorescent label) overlaps the signal intensity of the second fluorescent label (signal intensity 542: signal intensity in the first fluorescent label). The signal intensity average value of the second fluorescent label is INT (Main)=10000. The signal intensity average value of the first fluorescent label is INT (Sub)=2000. In this case, the pullup evaluated value is calculated as 0.2 by equation (5). The pullup evaluation processing unit 131 decides the larger one of the overlapping signal intensities as main and the smaller one as sub. Thus, the pullup evaluated value is the ratio of the main signal intensity (first fluorescent label) and the sub signal intensity (first fluorescent label).

The decision processing unit 106 makes a decision at Step S6B in FIG. 20, based on the fluorescent color signal evaluated value and pullup evaluated value. The decision is to determine whether the next step is binning area adjustment processing (Step SB7 in FIG. 20) or binning pattern output processing (Step S8 in FIG. 20). If one of the fluorescent color signal evaluated value and the pullup evaluated value does not satisfy the prescribed criterion (S6B→No in FIG. 20: the prescribed condition is satisfied), the next step is binning area adjustment processing (Step S7B in FIG. 20). If the fluorescent color signal evaluated value and pullup evaluated value both satisfy the prescribed criterion (S6B→Yes in FIG. 20), the next step is processing by the binning pattern output unit 108 (Step S8 in FIG. 20). The prescribed criterion is, for example, that the value is not more than a prescribed threshold.

At Step S7B in FIG. 20, the binning area adjustment processing unit 107 not only performs processing at Step S7 in FIG. 5 (bin adjustment) but also reduces the bin width (size of bin 400) so as to make the peak signal charge integrated value smaller in the main fluorescent label (first fluorescent label) in which pullup has occurred.

In the third embodiment, the fluorescent color signal evaluated value and pullup evaluated value are judged at the same time at Step S6B in FIG. 20, but the judgment may be made in two steps. Specifically, if the fluorescent color signal evaluated value is not less than the prescribed threshold at Step S6B (S6B→Yes), the decision processing unit 106 may decide whether the pullup evaluated value is the prescribed threshold or more or not. If the pullup evaluated value is less than the prescribed threshold, the binning area adjustment processing unit 107 reduces the bin 400 near the peak signal intensity value of the main fluorescent label in which pullup has occurred. Also, the binning area adjustment processing unit 107 expands the bin 400 adjacent to the reduced bin 400. After that, the electrophoresis data processing device 1 returns the process to Step S2.

On the other hand, if the pullup evaluated value is not less than the prescribed threshold, Step S8 is carried out.

According to the third embodiment, the influence of pullup can be suppressed.

The electrophoresis data processing device 1 may include both the color conversion matrix evaluation processing unit 121 shown in FIG. 17 and the pullup evaluation processing unit 131 shown in FIG. 19.

In this configuration, if one of the fluorescent color signal evaluated value, color conversion matrix evaluated value and pullup evaluated value does not satisfy a prescribed criterion (S6B→No in FIG. 5), the next step is binning area adjustment processing (which corresponds to Step S7 in FIG. 5). If the fluorescent color signal evaluated value, color conversion matrix evaluated value and pullup evaluated value all satisfy the prescribed criterion (which corresponds to S6→Yes in FIG. 5), the next step is binning pattern output (which corresponds to Step S8 in FIG. 5).

It should be noted that the present invention is not limited to the examples described above, and includes various modification examples. For example, the examples described above have been described in detail to simply describe the present invention, and are not necessarily required to include all the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

Some or all of the abovementioned elements, functions, units 101 to 108, 121, 131, storage device 113, etc. may be embodied as hardware, for example, by design of integrated circuitry. Also, as shown in FIG. 2, the abovementioned elements, functions, etc. may be embodied as software by a processor such as the CPU 112 which interprets and executes the programs to realize various functions. The programs to realize various functions and information such as tables and files may be stored not only in a HD (Hard Disk) but also in a memory, a storage device such as SSD (Solid State Drive) or a recording medium such as an IC (Integrated Circuit) card, SD (Secure Digital) card and DVD (Digital Versatile Disc).

In each embodiment, the control lines and information lines which are shown are the lines considered as necessary for explanation and do not represent all control lines and information lines in the product. Actually, almost all the elements may be considered to be connected with each other.

### LIST OF REFERENCE SIGNS

1: 1a, 1b: electrophoresis data processing device
2: electrophoresis device
101: signal charge data acquisition unit (acquisition unit)
102: binning processing unit (bin generating unit)
103: color conversion matrix calculation processing unit (bin value extraction unit)
104: color conversion processing unit (signal intensity calculation unit)
105: color signal evaluation processing unit (first evaluated value calculation unit)
106: decision processing unit
107: binning area adjustment processing unit (adjustment unit)
108: binning pattern output unit
109: input/output processing unit (display processing unit)
113: storage device
114: input device (input unit)
115: display device (display unit)
121: color conversion matrix evaluation processing unit (second
evaluated value calculation unit)
131: pullup evaluation processing unit (third evaluated value calculation unit)
201: wavelength dispersion unit
202: signal charge acquisition unit (imaging element)
203: signal charge data output unit
301: CCD pixel
400, 401-403, 411-430: bin
501-504: peak (second peak)
511-514: spectrum (including the first peak)
521-524, 541-544, 541a: signal intensity
531-534: signal intensity average value (value for the first peak)
600: menu screen
601: analysis start button (electrophoresis start button)
602: analysis sample set button
603: fluorescence sensitivity adjustment button
604: maintenance button
610: dialog screen (display to urge processing by the bin generating unit, signal intensity calculation unit and adjustment unit)
620: fluorescence sensitivity adjustment screen
621: sample content input window
622: set confirmation button
623: start button
Z, Za, Zb: electrophoresis system
S0: screen display processing (display processing step)
S1: acquisition of signal charge data (acquiring step)
S2: binning processing (bin generating step)
S3: color conversion matrix calculation processing (bin value extraction step)
S4: color conversion processing (signal intensity calculation step)
S5: color signal evaluation processing (evaluated value calculation step)
S7, S7A, S7B: binning adjustment processing (adjustment step)

The invention claimed is:

1. An electrophoresis data processing device comprising:
an acquisition unit that, when a plurality of imaging elements of an electrophoresis device in which a plurality of fluorescent labels are migrated together with a sample detect a signal for each wavelength component of fluorescence of the fluorescent labels and output pixel data obtained by conversion of the signal into an electric signal, acquires the pixel data output from the imaging elements from each of the imaging elements;
a bin generating unit that calculates an integrated value or a representative value of values of a given number of the adjacent pixel data, takes the calculated integrated value or the calculated representative value as a bin value, to combine the given number of the adjacent pixel data into one bin;
a bin value extraction unit that extracts a set of the bin values derived from the fluorescent labels for each of the fluorescent labels;
a signal intensity calculation unit that calculates a signal intensity of each of the fluorescent labels based on the set of the extracted bin values;
a first evaluated value calculation unit that calculates a first evaluated value as an evaluated value indicating a degree of variation in the signal intensity of each of the fluorescent labels; and
an adjustment unit that, when the first evaluated value satisfies a prescribed condition, makes a bin adjustment to reduce a size of the bin with the largest bin value that is the largest bin value in the set of bin values for the fluorescent label with the largest value of a first peak as a signal intensity peak, and to expand the size of the bin with the largest bin value for the fluorescent label with the smallest value of the first peak.

2. The electrophoresis data processing device according to claim 1, wherein
the bin generating unit calculates the bin value by calculating a signal charge integrated value as an integrated value of values of the pixel data of each of the bins,
the bin value extraction unit
extracts a second peak as a peak corresponding to the fluorescent label from a time series of the signal charge integrated values, extracts the signal charge integrated value constituting the second peak for each of the second peaks, takes the extracted individual second peaks as a component for a row and the bins as a component for a column, and calculates a conversion matrix as a matrix having the signal charge integrated values as individual component values to extract a set of the bin values derived from the fluorescent label, and
the signal intensity calculation unit
takes a scan number of the fluorescence as a component for a row and the bins as a component for a column in the time series of the signal charge integrated values, and acquires a time series of signal intensities of each of the fluorescent labels by multiplying a signal charge integration matrix as a matrix having the signal charge integrated values as individual component values by an inverse matrix of the conversion matrix, to calculate a signal intensity of each of the fluorescent labels based on the set of the extracted bin values.

3. The electrophoresis data processing device according to claim 2, comprising:
a second evaluated value calculation unit that calculates a second evaluated value as an evaluated value for calculation accuracy in calculating a signal intensity of each of the fluorescent labels based on the conversion matrix, wherein
the adjustment unit,
when the first evaluated value and the second evaluated value satisfy a prescribed condition, not only makes the bin adjustment but also makes the calculation accuracy higher than current calculation accuracy.

4. The electrophoresis data processing device according to claim 1, comprising:
a third evaluated value calculation unit that, when a signal intensity of a second fluorescent label as the other fluorescent label overlaps the signal intensity of a first fluorescent label as the specific fluorescent label, calculates a third evaluated value as a ratio of the signal intensity of the first fluorescent label and the signal intensity of the second fluorescent label, wherein
when the first evaluated value and the third evaluated value satisfy a prescribed condition, the adjustment unit not only makes the bin adjustment but also reduces a size of a bin corresponding to the largest bin value for the first fluorescent label.

5. An electrophoresis data processing device comprising:
an acquisition unit that, when a plurality of imaging elements of an electrophoresis device in which a plurality of fluorescent labels are migrated together with a sample detect a signal for each wavelength component of fluorescence of the fluorescent labels and output pixel data obtained by conversion of the signal into an electric signal, acquires the pixel data output from the imaging elements from each of the imaging elements;
a bin generating unit that calculates an integrated value or a representative value of values of a given number of the adjacent pixel data, takes the calculated integrated value or the calculated representative value as a bin value and combines the given number of the adjacent pixel data into one bin;
a bin value extraction unit that extracts a set of the bin values derived from the fluorescent labels for each of the fluorescent labels;
a signal intensity calculation unit that calculates a signal intensity of each of the fluorescent labels based on the set of the extracted bin values;
an evaluated value calculation unit that calculates an evaluated value indicating a degree of variation in the signal intensity of each of the fluorescent labels;
an adjustment unit that, when the evaluated value satisfies a prescribed condition, makes a bin adjustment to reduce a size of the bin with the largest bin value that is the largest bin value in the set of bin values for the fluorescent label with the largest value of the signal intensity peak and to expand the size of the bin with the largest bin value for the fluorescent label with the smallest value of the signal intensity peak; and
a display processing unit that displays on a display unit a sensitivity adjustment start button as a button to start sensitivity adjustment for each fluorescent label, wherein
processing by the acquisition unit, the bin generating unit, the bin value extraction unit, the signal intensity calculation unit, the evaluated value calculation unit, and the adjustment unit is started by selecting the sensitivity adjustment start button through an input unit.

6. The electrophoresis data processing device according to claim 5, wherein
the display unit displays not only the sensitivity adjustment start button but also an electrophoresis start button as a button to start electrophoresis by the electrophoresis device, and
when the electrophoresis start button is selected through the input unit before processing by the bin generating unit, processing by the signal intensity calculation unit, and processing by the adjustment unit are performed, the display processing unit displays on the display unit a message to urge processings to the display unit by the acquisition unit, the bin generating unit, the bin value extraction unit, the signal intensity calculation unit, the evaluated value calculation unit, and the adjustment unit.

7. An electrophoresis data processing method performing:
a display processing step of displaying on the display unit a sensitivity adjustment start button as a button to start sensitivity adjustment for each fluorescent label;
an acquisition step of, when a plurality of imaging elements of an electrophoresis device in which a plurality of fluorescent labels are migrated together with a sample detect a signal for each wavelength component of fluorescence of the fluorescent labels by the selection of the sensitivity adjustment start button through the input unit and output pixel data obtained by conversion of the signal into an electric signal, acquiring the pixel data output from the imaging elements from each of the imaging elements;
a bin generating step of calculating an integrated value or a representative value of values of a given number of the adjacent pixel data, taking the calculated integrated value or the calculated representative value as a bin value, to combine the given number of the adjacent pixel data into one bin;
a bin value extraction step of extracting a set of the bin values derived from the fluorescent labels for each of the fluorescent labels;
a signal intensity calculation unit of calculating a signal intensity of each of the fluorescent labels based on the set of the extracted bin values; and
an evaluated value calculation step of calculating an evaluated value indicating a degree of variation in the signal intensity of each of the fluorescent labels; and
an adjustment step of, when the first evaluated value satisfies a prescribed condition, making a bin adjustment to reduce a size of the bin with the largest bin value that is a largest bin value in the set of bin values for the fluorescent label with the largest value of a signal intensity peak, and to expand the size of the bin with the largest bin value for the fluorescent label with the smallest value of the signal intensity peak.

8. The electrophoresis data processing method according to claim 7, wherein the bin generating step, the bin value extraction step, the signal intensity calculation step, the evaluated value calculation step, and the adjustment step are repeated until the evaluated value does not satisfy a prescribed condition.
